(19) United States
(12) Patent Application Publication
(10) Pub. No.: US 2026/0025552 A1
(43) Pub. Date: Jan. 22, 2026

(54) Navigation-based Pre-fetching for Just-in-Time Delivery

(71) Applicant: GoPro, Inc., San Mateo, CA (US)

(72) Inventors: Daniel Dennedy, Oceanside, CA (US); Rahul Iyengar, Union City, CA (US)

(73) Assignee: GoPro, Inc., San Mateo, CA (US)

(21) Appl. No.: 18/773,885

(22) Filed: Jul. 16, 2024

(51) Int. Cl. H04N 21/466; H04N 21/239; H04N 21/433; H04N 21/437; H04N 21/442

(52) U.S. Cl. CPC H04N 21/4668; H04N 21/2393; H04N 21/4331; H04N 21/437; H04N 21/44222

(57) ABSTRACT

Methods and apparatus for navigation-based prefetching for just-in-time delivery. Existing content delivery networks (CDNs) are optimized for providing mass media to many consumers. This delivery model is poorly suited to user-specific content. An exemplary client application uses a first user agent to play media, and one or more second user agent(s) that prefetch media. A prefetch process “pre-warms” the CDN, such that the media content is transferred to the appropriate edge server for just-in-time playback by the player agent. In one specific implementation, the prefetch agent monitors user actions (e.g., navigation, etc.) to anticipate user media selections. Anticipated candidates are eagerly prefetched.

### RELATED APPLICATIONS

This application is related to U.S. patent application Ser. No. 17/320,503 filed May 14, 2021, and entitled “METHODS AND APPARATUS FOR JUST-IN-TIME STREAMING MEDIA”, incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates to content delivery. Specifically, the present disclosure relates to streaming media, such as within consumer media applications.

### DESCRIPTION OF RELATED TECHNOLOGY

Existing schemes for content delivery often leverage content delivery networks (CDN); CDNs are geographically distributed networks of proxy servers that can provide media to users from local media caches. The close proximity service can offer higher performance and availability for the cached files. CDN-based distribution often must balance file size, frequency of use, and quality. Thus, for example, CDNs are best used to provide frequently requested content (popular media titles, etc.) to large populations of viewers.

Unfortunately, the vast majority of content has been popular mass media (commercial movies, television, etc.), and so most CDNs have neglected other use cases. For example, conventional CDNs are not well suited to handle less popular media formats (e.g., highest quality media), infrequently accessed archival media, and/or user-specific media (home videos, etc.). More recently however, widespread broadband and changes in consumer behavior have resulted in more focus on niche and individualistic tastes.

In 2016, GoPro, Inc. launched cloud services that provide users access to their own individual footage and photos from anywhere, anytime, and at native capture resolution quality. The service has steadily grown in popularity, and now, new and improved solutions are needed for handling user-specific media, at high quality (natively captured, without image quality degradation), in aggressive consumer usage scenarios (live streaming).

### BRIEF DESCRIPTION OF THE DRAWINGS

FIG. 1 is a logical block diagram of one streaming network architecture useful in explaining various aspects of the present disclosure.

FIG. 2 is a graphical representation of one file system useful for providing variable bit rate streaming packets, useful in explaining various aspects of the present disclosure.

FIG. 3 is a logical block diagram of a network architecture for just-in-time streaming media, useful in explaining various aspects of the present disclosure.

FIG. 4 is a graphical illustration of static data structures that are useful in explaining various aspects of the present disclosure.

FIG. 5 is a logical block diagram of a method for just-in-time streaming media, useful in explaining various aspects of the present disclosure.

FIG. 6 is a logical sequence diagram of a first just-in-time streaming scenario, useful in explaining various aspects of the present disclosure.

FIG. 7 is a graphical illustration of an exemplary navigation interface, useful in explaining various aspects of the present disclosure.

FIG. 8 is a logical sequence diagram of a first just-in-time streaming scenario, in accordance with various aspects of the present disclosure.

FIG. 9 is a logical sequence diagram of a second just-in-time streaming scenario, in accordance with various aspects of the present disclosure.

FIG. 10 is a logical block diagram of an exemplary system, in accordance with various aspects of the present disclosure.

FIG. 11 is a logical block diagram of a media playback device, in accordance with various aspects of the present disclosure.

### DETAILED DESCRIPTION

In the following detailed description, reference is made to the accompanying drawings which form a part hereof, wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

### Content Delivery Networks and Streaming Delivery

As a brief aside, a Content Delivery Network (CDN) is a distributed system of servers located across various geographical regions to deliver web content and services to users more efficiently. A conventional CDN may have “edge servers”, “origin servers”, and a network of intermediary data centers. Edge servers are positioned at multiple locations close to the end users to cache and deliver content swiftly, reducing latency and improving load times. Origin servers host the original version of the content and respond to requests that cannot be fulfilled by the edge servers. Intermediary data centers in the network ensure redundancy, load balancing, and high availability of content.

In conventional CDN operation, a user requests content from a CDN. The CDN directs the user's request to the edge server that can best handle the user request, e.g., the geographically closest edge server. If the requested content is already cached at the assigned edge server, then the data can be immediately delivered, resulting in very low latency and a smooth user experience. If the data is not already cached at the edge server, but is present elsewhere, then the CDN routes the requested data via the intermediary data centers to the assigned edge server.

Most Content Delivery Networks (CDNs) support two types of media delivery: file download and streaming. File downloads transfer media in aggregate; the media may be packetized and delivered over transport protocols. In many cases, file downloads can benefit from network transport layer safeguards e.g., data that is lost can be corrected and resent, network congestion can be mitigated, etc. Notably, archival video formats are designed for storage and must be downloaded in full before playback or use. However, since most videos are multiple Gigabytes (GB) in size, archival formats are seldom used for video delivery.

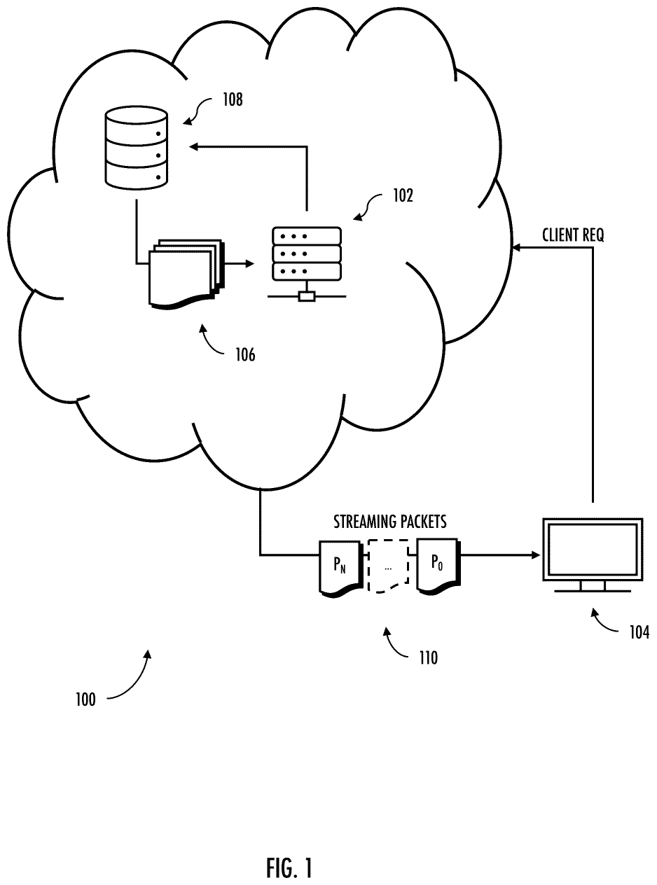

Streaming media formats transfer media as playable segments (e.g., 2 second snippets, etc.). Referring now to FIG. 1, a logical block diagram of a streaming network architecture 100 useful in explaining various aspects of the present disclosure is depicted. The streaming network architecture 100 may include content servers 102. The content servers 102 may be configured to communicate with a client device 104 according to a client/server protocol. Client/server protocols enable a few servers to service many clients; each client can access the server's resources to complete client-side tasks. In order to optimize client interactions, the server caches frequently used data e.g., popular media. As shown, a client device 104 requests content from content servers 102; the content servers 102 obtain the necessary streaming files 106 from a file repository 108. The streaming files have been pre-segmented into packets 110 that can be sent to the client for playback. In this manner, the user can start the streaming video playback as soon as it has received (and buffered) a few packets, but before the entire video is received.

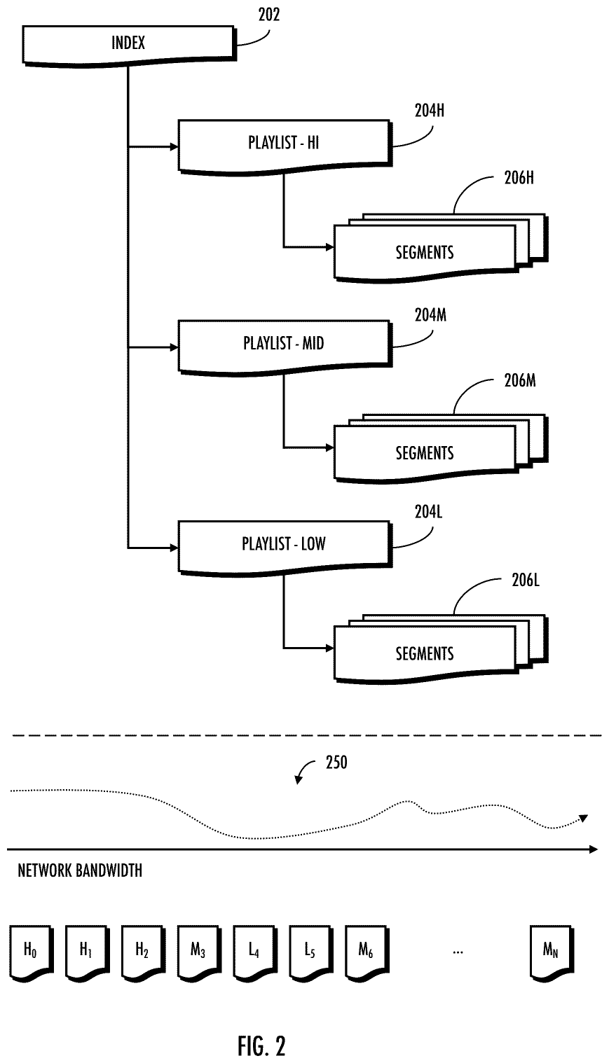

Even though streaming delivery allows the user to start playback before all the packets of a media file are received, only packets that have been received in full can be played. Missing packets and/or corrupted packets must be skipped which can result in poor user experience. Consequently, certain streaming implementations use variable bit rate packets to optimize performance over fluctuating network conditions. FIG. 2 presents one scheme for providing variable bit rate streaming packets, useful in explaining various aspects of the present disclosure. As shown therein, the streaming files may be segmented into 3 components: (i) a top-level index 202, (ii) a rate specific playlist 204H, 204M, 204L, and (iii) video segments of varying quality 206H, 206M, 206L. These files may be organized into a hierarchical directory structure as follows:

```
./toplevelindex/
./toplevelindex/playlist_hi/
./toplevelindex/playlist_hi/segment_t0.ts
./toplevelindex/playlist_hi/segment_t1.ts
  ...
./toplevelindex/playlist_hi/segment_tN.ts
./toplevelindex/playlist_mid/
./toplevelindex/playlist_mid/segment_t0.ts
./toplevelindex/playlist_mid/segment_t1.ts
  ...
./toplevelindex/playlist_mid/segment_tN.ts
./toplevelindex/playlist_low/
./toplevelindex/playlist_low/segment_t0.ts
./toplevelindex/playlist_low/segment_t1.ts
  ...
./toplevelindex/playlist_low/segment_tN.ts
```

As shown in FIG. 2, variable bit rate streaming packets can be used to provide reduced quality packets during periods of low network bandwidth. In the illustrated scenario 250, high quality video packets (H₀, H₁, H₂, etc.) can be provided while bandwidth is good. Lower quality packets (M₃, L₄, L₅, etc.) may be provided when bandwidth has been reduced. Providing reduced (but still playable) video quality is generally preferred over attempting to send higher quality packets that may be dropped.

As a practical matter, streaming data structures take considerably more space and resources than e.g., archival video. The foregoing streaming discussion is broadly representative of mass media CDNs that accommodate a large population of users that decode the same media many times over many different network conditions. In contrast, so-called “just-in-time” delivery refers to streaming techniques that are designed to stream directly from archival formats. Such techniques used for media that is highly user specific, infrequently requested, and/or requested at unusual/non-standard resolutions (e.g., natively captured resolutions, etc.).

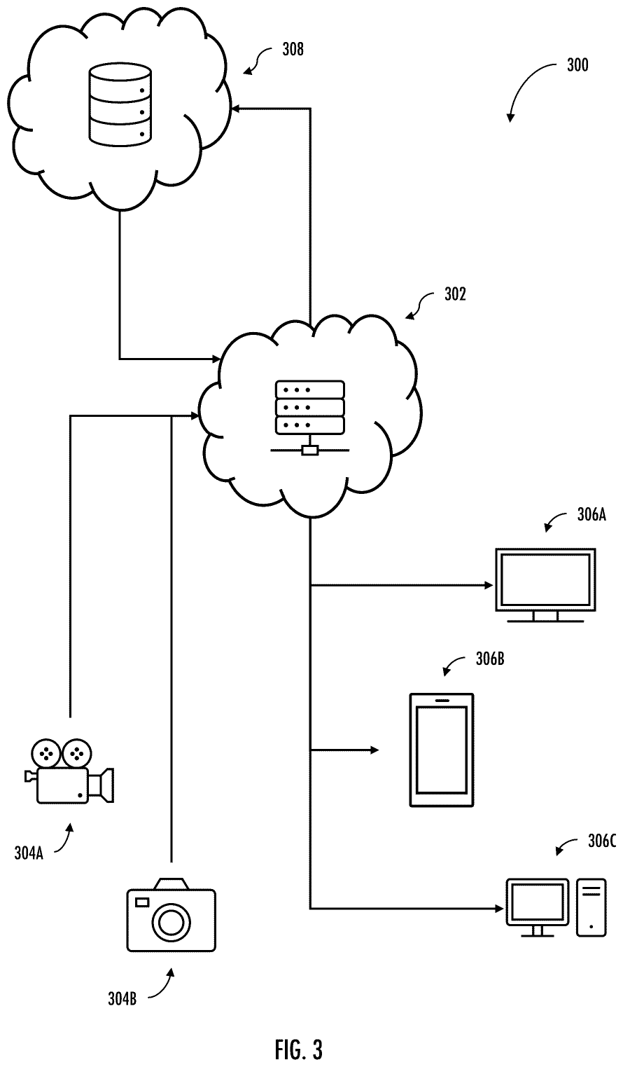

FIG. 3 is a logical block diagram of a network architecture 300 for just-in-time streaming media, particularly useful for delivering user-specific, high quality media formats, from archival data storage. Network architecture 300 may include content servers 302. The content servers 302 are configured to communicate with capture devices 304A, 304B and playback devices 306A, 306B, 306C, according to a client/server protocol. Here, the content servers 302 obtain user generated audio/visual (AV) media (images, audio, and/or video) from capture devices 304A, 304B; the media is archived for long-term storage via the archival service 308. In some cases, the media may be archived in its original captured format; in other cases, the media may be encoded to an archival format.

At a later point in time, the content servers may receive media requests from the playback devices 306A, 306B, 306C. The media requests support variable bit rate streaming delivery e.g., MPEG-2 transport streams via HTTP Live Streaming (HLS). Responsively, the content servers obtain the requested media from the archival service and transmux or transcode some or all of the content just-in-time. Specifically, the content servers transmultiplex/transcode the media content from the stored format (e.g., original or archival) into a format suitable for streaming delivery. In one specific implementation, a MPEG-4 archival copy is transmultiplexed or “transmuxed” (e.g., re-packaging or re-packetizing media files into a different delivery formats without changing the files' contents) into an MPEG-2 transport stream for delivery over HTTP Live Streaming (HLS). In another specific implementation, a MPEG-4 archival copy is transcoded (e.g., decoded and then re-encoded into a different delivery format) into an MPEG-2 transport stream for delivery over HTTP Live Streaming (HLS).

Consider the following scenario: a user subscribes to a cloud service for their user generated content. The cloud service offers native resolution archival and live streaming via the Internet. While on vacation, the user captures a MPEG-4 1080p video (e.g., capture devices 304A, 304B) and the video is archived in its native resolution (e.g., at archival service 308). The user additionally generates a reduced resolution version of their video for sharing via social media on mobile devices (e.g., cached at content servers 302). A few months later, the user decides to stream their vacation videos.

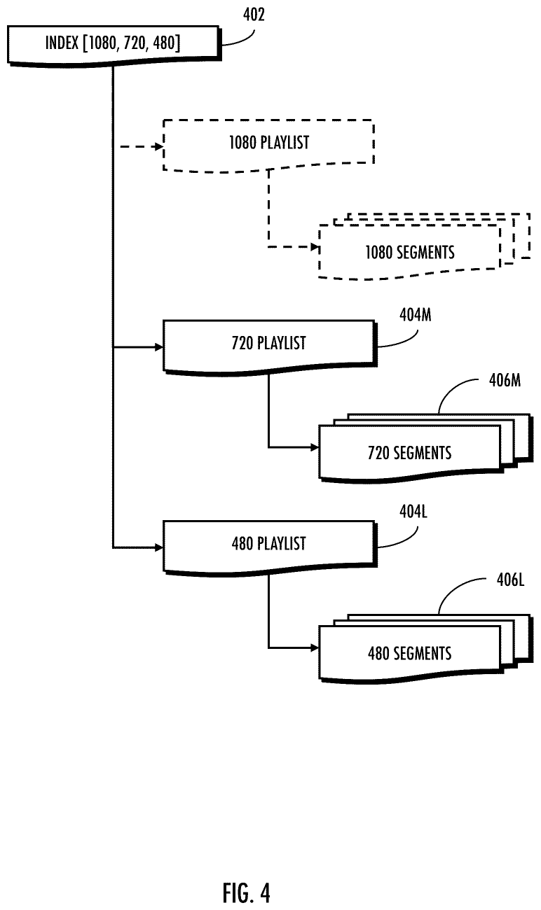

In order to maximize user experience, the cloud service prepares a video stream at the highest quality. In this scenario, the server can support HTTP Live Streaming (HLS) in both 720p and 480p, but 1080p HLS must be generated near real-time from the archival copy. FIG. 4 is a graphical illustration of the static data structures that are initially present at content servers 302. The static data structure may be organized into a hierarchical directory structure as follows:

```
./toplevelindex/
./toplevelindex/playlist_720
./toplevelindex/playlist_720/segment_t0.ts
./toplevelindex/playlist_720/segment_t1.ts
  ...
./toplevelindex/playlist_720/segment_tN.ts
./toplevelindex/playlist_480
./toplevelindex/playlist_480/segment_t0.ts
./toplevelindex/playlist_480/segment_t1.ts
  ...
./toplevelindex/playlist_480/segment_tN.ts
```

As shown in FIG. 4, the streaming files include: (i) a top-level index 402, (ii) rate specific playlists for each of the 720p and 480p videos (404M, 404L), and (iii) corresponding video segments (406M, 406L). The user's 1080p video is archived as an MPEG-4 file on an external server and is not available locally as HLS assets. In this scenario, the server can support HTTP Live Streaming (HLS) in both 720p and 480p, but 1080p HLS must be generated near real-time from the archival copy.

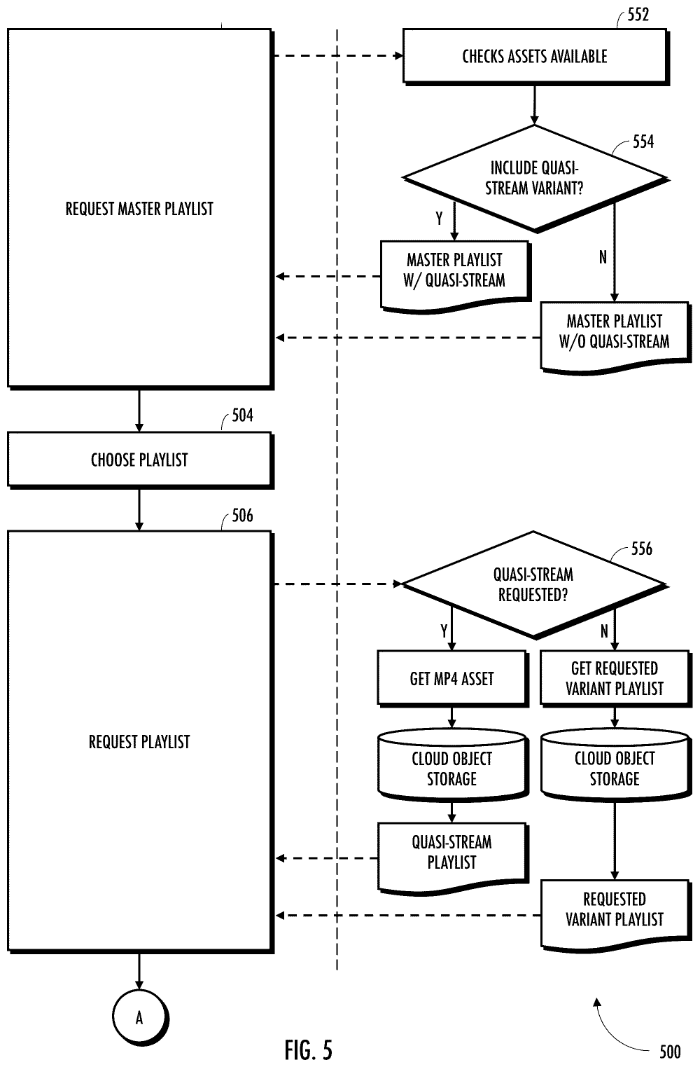

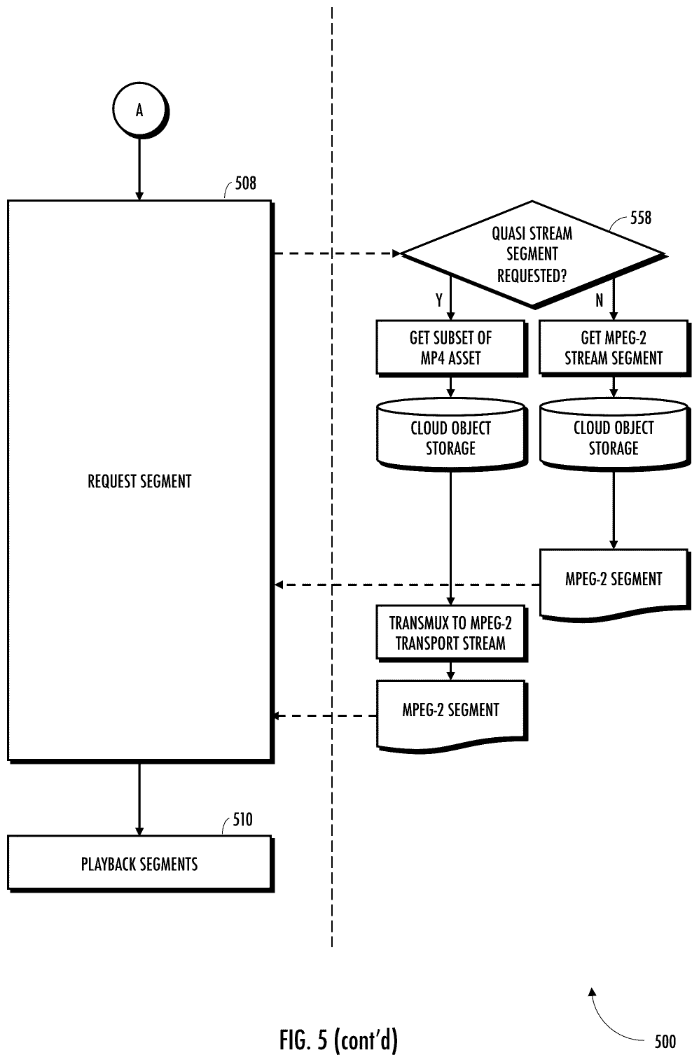

FIG. 5 provides a logical flow diagram 500 useful to explain just-in-time streaming. As shown, a client device requests a master playlist to stream an asset (step 502). The server responsive checks its available assets (steps 552); in this example, the locally available streaming assets include the 720p assets (404M, 406M) and the 480p assets (404L, 406L). Additionally, the server accesses its file archives (e.g., via a server/archival query to the archival service 308); in this case, the server determines that a 1080p MPEG-4 file has been archived.

The server considers a variety of system factors to decide whether the 1080p MPEG-4 file should be included (step 554) as a quasi-streamable asset. In this case, the server checks the current client device capability and network connection quality; and decides to return a master playlist that includes both the available streaming assets, as well as a quasi-streamable asset (derived from the 1080p MPEG-4 file.) More broadly, the server may consider network congestion, device capability, bandwidth to the archival service, bandwidth to the user device, user device capability (display size, processing and/or memory resources, etc.), historic network performance, and/or any other system consideration. In some cases, the server may also consider user-specific factors; examples of such considerations may include e.g., user priority, media type, history of use, etc.

At step 504, the client device selects the desired playlist. In some cases, the playlist options may be manually selected by a user. Alternatively, the client device may default to a particular playlist based on device considerations and user preferences. For example, a user device may select the highest available quality playlist to maximize the user's visual experience. Alternatively, the user device may always the lowest available quality to preserve power, etc. Still other variants may select an appropriate resolution so as to balance the other client device considerations (e.g., web browsing, games, other media playback, etc.)

At step 506, the client requests the desired playlist; responsively, the server determines whether the quasi-streamable asset is requested (step 556). If a streamable asset is selected, then the server provides the requested variant playlist as-is (either 720p or 480p). Otherwise, if the quasi-streamable asset playlist is requested, then the server instantiates a program instance to provide a file system-like application programming interface (API) to the archival MPEG-4 file (described in greater detail below). Additionally, the server generates a quasi-streamable asset playlist based on one of the available resolution playlists by, e.g., replacing the resolution identifier “720p” (or “480p”) with “1080p”; as shown below, the quasi-streamable asset would appear to indicate the presence of a 1080p file structure (even though no such file structure exists):

./toplevelindex/playlist_1080
./toplevelindex/playlist_1080/segment_t0.ts
./toplevelindex/playlist_1080/segment_t1.ts
...
./toplevelindex/playlist_1080/segment_tN.ts

Notably, MPEG-4 (and MPEG-2) supports segments of any arbitrary length (e.g., 1 second, 2 second, etc.) In this case, the natively captured user generated content is encoded with specific time increments. Subsequent down-conversion to reduced resolution formats retains the same time increments. Thus, for example, the user's initially captured 1080p video may be segmented at 2 second divisions, which is preserved across each of the reduced resolution HLS versions (720p, 480p). Consequently, even though the MPEG-4 archival file is not segmented for HLS, the internal file structure can be de-referenced to obtain 2 second 1080p chunks.

The file system-like API is configured to parse the network HTTP socket requests for file structure locations and return packets with the data parsed from an MPEG-4 file. Thus, ./toplevelindex/playlist_1080/segment_tX.ts returns the segment X parsed from the 1080p archival MPEG-4 file (e.g., based on the track, media, media information, sample table, chunk map, chunk offset, and decode time information stored therein).

The client may then request segments for playback according to its master playlist (steps 508, 510). If a segment from the quasi-streamable asset playlist is requested (step 558), then the server's running program instance transmultiplexes/transcodes chunks from the 1080p MPEG-4 archival file into an MPEG-2 HLS transport stream. MPEG-2 transport stream segments (from 720p and 480p) can be handled using the existing file structure. In this manner, a full 1080p MPEG-2 transport stream over HLS can be generated in near real-time to service the client device requests.

A variety of other improvements, alterative implementations, and/or other applications for just-in-time delivery are discussed in greater detail within U.S. patent application Ser. No. 17/320,503 filed May 14, 2021, and entitled “METHODS AND APPARATUS FOR JUST-IN-TIME STREAMING MEDIA”, incorporated by reference in its entirety.

### Exemplary Navigation-Based Prefetching for Just-In-Time Delivery

Conventional CDNs make several assumptions regarding the nature and behavior of content being delivered. First, conventional CDNs are best used in scenarios where content is primarily static or semi-static such that it can be effectively cached at various points in the network. Second, these types of CDNs assume that content may be requested by any arbitrary user across their covered geographic regions; typically, this necessitates widespread placement and distribution to minimize latency and ensure rapid delivery. Third, most CDNs assume that different content will have varying levels of demand; popular content can be widely distributed, less popular content may be more thinly distributed (if at all). In some cases, CDNs will “entice” users to drive traffic toward popular content. In other words, CDNs are designed to efficiently deliver a relatively small subset of popular media to a large group of users over large swathes of land. Conventional CDN architectures are ill-suited for infrequent and/or atypical requests—these situations are difficult to accurately prepare-for.

GoPro, Inc. provides cloud services that provide users access to their own individual footage and photos from anywhere, anytime, and at native capture resolution quality. Unlike mass media, user generated media is shot on devices that change every year according to aggressive market trends. Such media is often highly individual and user-specific, i.e., user generated media is most commonly used to memorialize important events at full fidelity (e.g., vacations, weddings, etc.) Typically, such content may be archived for long periods of time at native resolution, and then retrieved for manual editing and/or curated for specific use.

In terms of technology, GoPro's products circa 2023 encode videos and images at MPEG-4. MPEG-4 is a much more advanced encoding standard than MPEG-2; MPEG-4 has substantial advantages over MPEG-2 when considered in the specific context of user generated content. Notably, MPEG-4 uses a discrete cosine transform with a larger block size (16×16 versus 8×8 of MPEG-2); the larger block size of MPEG-4 allows for a much higher compression rate for the same image quality when compared to MPEG-2, this is desirable when archiving high image quality footage. In terms of image quality, the larger block sizes of MPEG-4 are also designed to support larger display sizes and higher resolutions such as are commonly found in niche consumer electronics markets.

Most content delivery mechanisms are focused on “short-tail” content. So-called “short-tail” content refers to content that has generic broad-based appeal—this type of content attracts high initial demand but then quickly tails off. In contrast, long-tail content refers to content that has strong and lasting connection to an audience (often higher relative commercial value). These usage scenarios may require delivery of e.g., less popular media formats (e.g., highest quality media), infrequently accessed archival media, and/or user-specific media (home videos, etc.)—long-tail content is usually niche and difficult to address with conventional content delivery. For example, just-in-time streaming delivery of user-specific content is highly sought after by the consuming public, yet this is especially problematic for CDNs since the segments are generated as-needed (not prepared in advance).

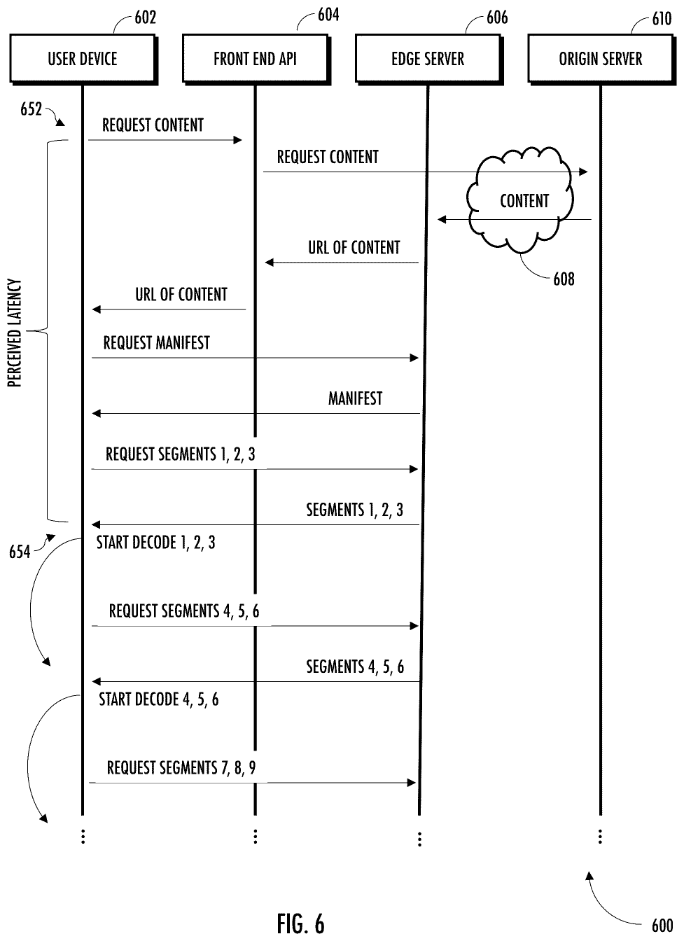

Consider the just-in-time streaming scenario 600 of FIG. 6. As shown, a user device 602 communicates with a front-end API 604 (application programming interface) of a CDN-based streaming service. The front-end API 604 provides control plane functionality to manage the data plane back-end (e.g., an edge server 606, intermediary data centers 608, and an origin server 610).

Here, the control plane manages and configures the CDN for asset delivery. For example, control plane signaling may convey the routing and forwarding decisions, control policies, and network topology information. In contrast, the data plane transmits the assets to the end user based on the information and rules provided by the control plane.

At time 652, the user requests streaming content using the front-end API 604. The front-end API 604 determines that the requested content is not present at the edge server 606 and must be retrieved from archival at the origin server 610. The CDN begins the process of generating a manifest (which may include both streamable and quasi-streamable assets). Depending on implementation, any one of the edge servers, intermediary data centers 608, and/or the origin server 610 may transmultiplex/transcode chunks from the archival file into segments for the transport stream. The network locations (URLs) of the manifest and assets are provided to the front-end API 604 which generates the response to the user request.

The user device 602 can begin streaming operation once it has the network locations (URLs) of the manifest and assets. Specifically, the user device 602 requests the manifest from its network location at edge server 606 and then begins downloading the streamable and/or quasi-streamable assets. Once enough segments have been buffered, the streaming decode is started (time 654).

As shown in FIG. 6, the perceived latency between when the user first requests streaming content (time 652) and when the streaming decode is started (time 654) may be quite substantial. This latency may be noticeable (several seconds) and detract from the user's overall experience. Certain operations significantly contribute to latency e.g., retrieving content that was not cached at the edge server, and transmultiplexing/transcoding for streaming delivery, etc.

As a separate but related tangent, user generated content is often accessed with a specific purpose in mind. For example, a user will navigate through their media library toward their media of interest. In fact, the user may even have organized their media according to their own tastes (e.g., vacation videos may be grouped together, special events may be grouped together, etc.). In other words, a user's navigation patterns through their media library has a high correlation with what they are about to view (compared to e.g., browsing aimlessly through a catalog of mass media).

Exemplary embodiments of the present disclosure leverage navigation-based information to prefetch user-specific content for just-in-time delivery. In other words, the system attempts to “pre-warm” the CDN cache based on actions performed by the user.

Unlike conventional CDNs which often attempt to steer users toward previously cached content (e.g., Top 10 lists, Suggested for You, etc.), exemplary embodiments prefetch content based on what a user is navigating toward; e.g., a user may click to go to the detail page of the media, the user may be browsing through their media collection and going from one media to the other, etc. Various implementations may anticipate the user selection and/or eagerly prefetch content based on navigation. As discussed in greater detail hereinafter, the exemplary techniques leverage the advantages of existing CDN infrastructure. Additionally, some optimized variants may further improve efficiency with minor adjustments to system operation.

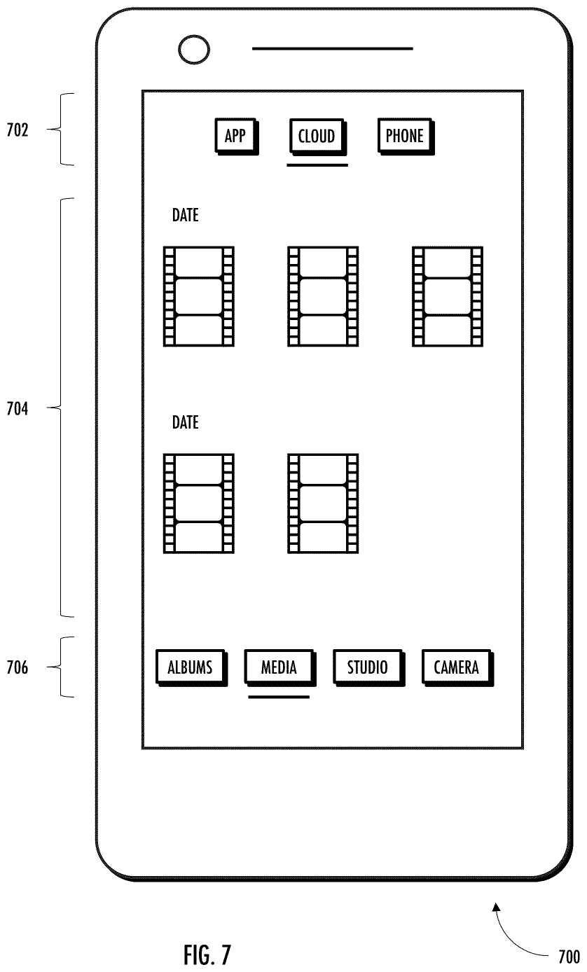

Here, “navigation” refers to the physical and/or virtual mechanisms that enable a user to select content of interest, from the set of available content. FIG. 7 is a graphical illustration of one such exemplary navigation interface 700. As shown, the user interface may allow a user to access media across multiple different locations (in-app data, cloud data, and/or other data available on the device) via a first selector 702. The user interface may present media in any number of ways; for example, media may be provided in a grid 704 (or “mural”) of chronologically organized thumbnail images that represent video streams. In some cases, the user interface may also allow a user to perform different actions (e.g., share albums with others, view media, edit media, download from/upload to another device, etc.) via a second selector 706. Any navigation scheme that allows a user to select and/or perform operations on media may be substituted with equal success.

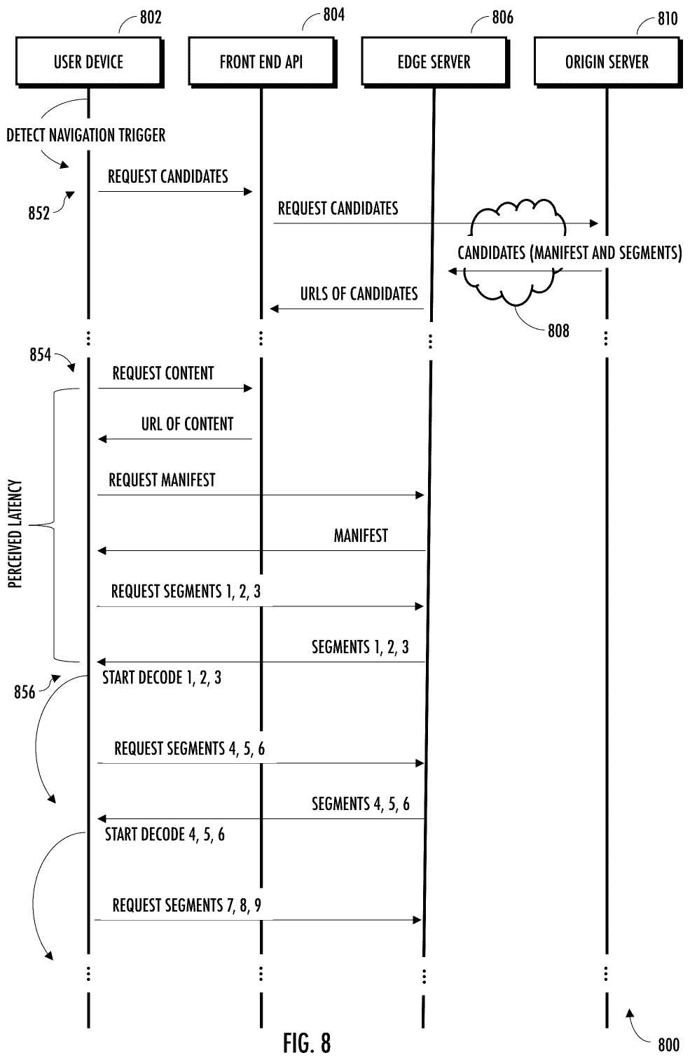

FIG. 8 is a ladder diagram of a first exemplary scenario 800, useful to explain various aspects of the present disclosure. Here, a user device 802 communicates with a front-end API 804 (application programming interface) of a CDN-based streaming service. The front-end API 804 provides control plane functionality to manage the data plane back-end (e.g., an edge server 806, intermediary data centers 808, and an origin server 810).

In one exemplary embodiment, the user device 802 may instantiate two or more user agents for a client application. Within this context, a “user agent” refers to a software component that acts on behalf of a user to perform tasks. Here, distinction is made between requests that are explicitly made by the user (e.g., via the user interface), and actions that are taken on behalf of the user (e.g., inferred from user actions by the processing subsystem). Conceptually, user agent interactions may or may not be apparent to the user—in other words, a player agent may service explicit user requests, whereas a prefetch agent may proactively take action (unbeknown to the user) based on likelihood of interest inferred from user activity.

Each user agent has a distinct set of data structures that interacts with web services or other network services. In HTTP, each user agent has a unique identifier, distinct from the client application. Here, a first user agent is a “player” agent (providing data to the web-based or app-based player); one or more additional user agents are “prefetch” agents (used to pre-warm the CDN). Importantly, the prefetch agents and player agents are serviced from the same edge server—e.g., the prefetch agents and player agents may be associated with the same IP address, which is assigned to a single edge server. This ensures that prefetched content is cached in a location that is also accessible by the player agent (not sitting at a different edge server).

During operation, the user navigates through their media library toward their video clip of interest. In this case, the user device has a locally stored grid of thumbnail images that represent video streams which are remotely stored within the cloud (CDN-based streaming service). The user device 802 tracks the user's navigation behavior to “anticipate” a user request for content based on likelihood of interest. Anticipatory predictions that exceed/fall below a threshold value may trigger an “eager” prefetch by the prefetch agents(s).

Consider a scenario where the user navigates to network storage (e.g., not in-app data nor locally stored on the device) for media playback and begins scrolling through the mural of candidates. The user device 802 monitors the speed (and/or velocity) at which the user navigates through thumbnails. Here, the user scrolls through years', months', weeks', etc. of thumbnails as they chronologically skip toward the date of their recording of interest. However, as they get closer, scrolling slows because the user begins to inspect each thumbnail more carefully. In other words, faster scrolling indicates less interest, slower scrolling indicates more interest.

In one specific implementation, scrolling rates may be compared to a threshold scroll rate; slowing below the threshold scrolling rate indicates that the user is spending more time looking at the mural. Here, viewing time indicates an increased likelihood of interest; as another such example, a spatial deviation from “center” may be used to infer that a user has “dragged” a mural into position to view it. In some cases, navigation direction may also be considered—e.g., a user that overshoots their target may change direction, possibly several times, to “zero-in” on their desired target. More generally, any predictive metric may be substituted for navigation-based metrics—e.g., a user may frequently view a particular clip, or sequence of clips, on certain dates (anniversaries) or near certain locations, etc.

At step 852, the user device 802 anticipates that the user will select one asset of a subset of assets, based on a navigation trigger. For example, if the user's finger drags the mural to center on a particular date range, then some or all, of the content for that date range is eagerly prefetched as potential candidates. The request for the subset of candidates is sent to the front-end API 804, which begins preparing the CDN data plane (e.g., the origin server 810 fetches the candidates and delivers them to the edge server 806 via the intermediary data centers 808). The edge server 806 that is associated with the user device 802 provides the network location of the candidates to the front-end API 804.

In this specific example, once the user device 802 determines that a user is interested in a set of content (potential candidates), the prefetch agent parses the HLS/DASH manifest and requests the individual segments for the stream. This “pre-warming” process increases the likelihood that the media segments that the client eventually requests will already be cached at the edge server by the time the request is made by the player agent.

When the user selects their content of interest (step 854), the front-end API 804 provides the network location of the precached content at the edge server 806. The user device 802 then downloads the manifest and then begins downloading the streamable and/or quasi-streamable assets. Once enough segments have been buffered, the streaming decode is started (time 856). The unselected prefetched candidates may be retained (e.g., a user may want to look at several videos for the date range) or discarded.

As shown in FIG. 8, the perceived latency between when the user first requests streaming content (step 852) and the streaming decode is started (time 856) has been substantially reduced. Specifically, the “transfer latency” associated with transferring the content from the origin server 810 to the edge server 806 is shortened by the anticipating navigation trigger. If the navigation trigger is detected far enough ahead of the user's actual selection, then the effective transfer latency may be completely obviated by the prefetching. In other words, this will lead to much speedier responses from a user's perspective and better quality of service for the stream.

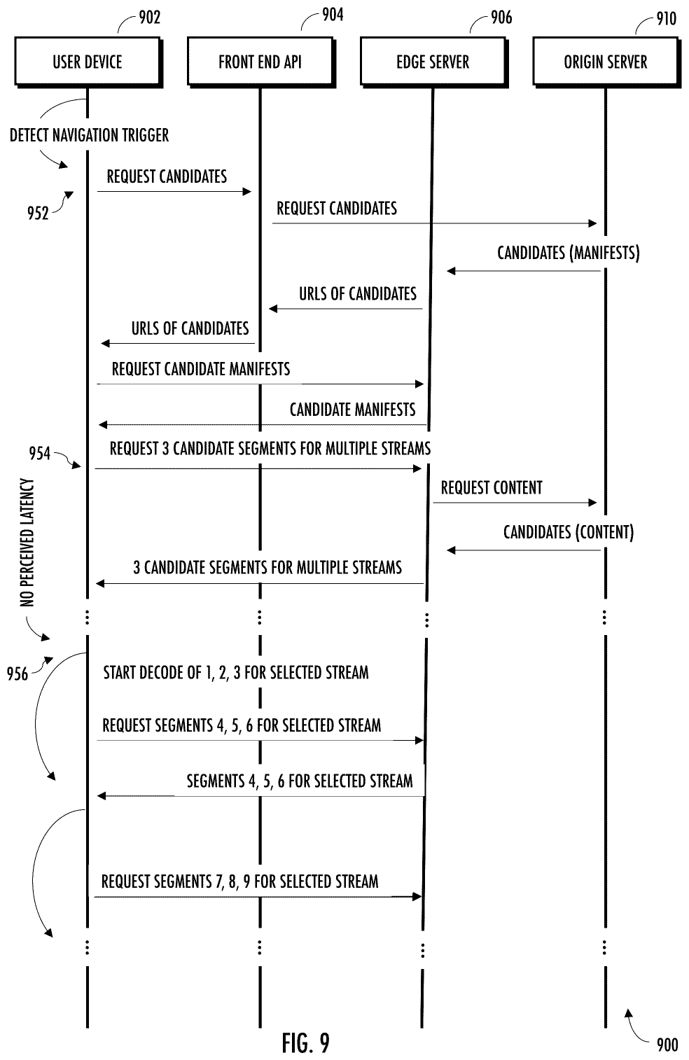

Conceptually, the prefetch agent of FIG. 8 has made a control plane request based on a navigation trigger, which causes the data plane to be configured in preparation for a data transfer to any subsequent agent (agent agnostic). However, some CDNs will not push data to an edge server until a data plane transfer is actually required. In other words, some CDNs may only initiate the content transfer from the origin server to the edge servers when a non-zero data plane transaction occurs. FIG. 9 presents an alternative implementation that initiates a data plane transfer based on a navigation trigger.

FIG. 9 is a ladder diagram of a second exemplary scenario 900, useful to explain various aspects of the present disclosure. Here, a user device 902 communicates with a front-end API 904 (application programming interface) of a CDN-based streaming service. The front-end API 904 provides control plane functionality to manage the data plane back-end (e.g., an edge server 906, intermediary data centers (not shown), and an origin server 910). As before, the user device 902 includes a client application that instantiates a player agent and one or more prefetch agents.

Much like the previously discussed scenario of FIG. 8, the user navigates through their media library toward their video clip of interest. The user device 902 tracks the user's navigation behavior to “anticipate” a user request for content to trigger an “eager” prefetch.

At step 952, the user device 902 anticipates that the user will select one asset of a subset of assets, based on a navigation trigger (e.g., slowed scrolling, etc.). The prefetch agent(s) request the subset of candidates via the front-end API 904, which begins preparing the CDN data plane for transfer. However, in this case, the “lazy” CDN only delivers manifests of network locations for the candidate content.

In order to pre-warm the edge server, the prefetch agent(s) of the user device obtains the candidate manifests and then begin to prefetch a few segments for local storage (step 954). In this case, the prefetch agent(s) downloads 3 segments for each viable candidate (e.g., 3 candidates would result in 9 segments, 4 candidates would result in 12 segments, etc.). In response, the CDN pushes the candidates' data from the origin server 910 to the edge server 906.

Since the requested media is destined for the prefetch agent(s) (not the player agent), the user device 802 may fire off multiple requests without waiting for the response. Each request is held open long enough to ensure that the requested media is cached on its associated edge server. In some variants, the requested media segments may be retained or discarded-so long as the edge server has locally cached the media, it may be re-downloaded with minimal latency.

In some variants, when the user selects their content of interest for playback, a small number of segments may have already been buffered by the prefetch agent—the prefetch agent for the selected content may provide its data over to the player agent. In this way, the streaming decode may be immediately started without any perceptible latency (time 956). In other words, the player agent need only pick-up where the prefetch agent left off.

One benefit of the navigation-based prefetching schemes is that they can directly leverage existing CDN infrastructure. The modifications to the control plane are handled within the client application at the user device. As a practical matter, these schemes are relatively inexpensive and much simpler to implement than other caching mechanisms which are controlled on the server side (within the CDN).

While the techniques can be used with legacy CDNs, some variants may additionally modify CDN operation to further optimize for navigation-based prefetching. For example, the data plane may enable “transfer-less” or “no-access” data plane transactions. Transfer-less data plane transactions move content from the origin server to the edge servers even when the data is not being accessed. Other improvements to the CDN may enable the CDN to e.g., recognize and distinguish between the different agents (the prefetch agent, the player agent, etc.) to accommodate their differences in operation. For example, a prefetch agent may only prefetch a small number of segments at the start of multiple clips in parallel, whereas the player agent may be configured to download any number of segments from any arbitrary location in a single file.

While the present disclosure is discussed in the context of smart phones and cameras, the concepts may be readily extended to other types of devices. For example, media playback may be triggered by spatial location to enable spatial computing; e.g., the spatial location of the user may be used to prefetch the video for playback. In one illustrative use case, a smart glasses user that walks into their room may see a virtual portrait that begins playing video, etc. As another example, media playback may be triggered by facial recognition or object recognition; e.g., smart glasses may identify a person by their face, and prefetch videos of previous interactions with the person.

As a related consideration, while the present disclosure is described in the context of touchscreen-based navigation (common with smart phones) to infer user interest, other types of user activity that indicate interest may be substituted with equal success. Smart glasses may use eye-tracking to identify what a user is looking at (and/or interested in viewing). A smart vehicle may use the steering wheel, console, and/or other user interface components to identify user interest, etc.

The illustrative examples provided above are discussed within the context of HTTP Live Streaming (HLS) playback. However, the concepts may be directly applied to other manifest based streaming delivery technologies (e.g., DASH, etc.). More generally, the concepts may be broadly extended to progressive download technologies across a variety of architectures and/or applications. Here progressive downloads refer to data transfer techniques that allow the file to be used (played, rendered, accessed, etc.) as it is being downloaded. Progressive techniques may encompass both streaming as well as non-streaming solutions. Progressive techniques may or may not e.g, use segmentation, dynamic bandwidth (resolution) adjustments, etc.

### System Architecture

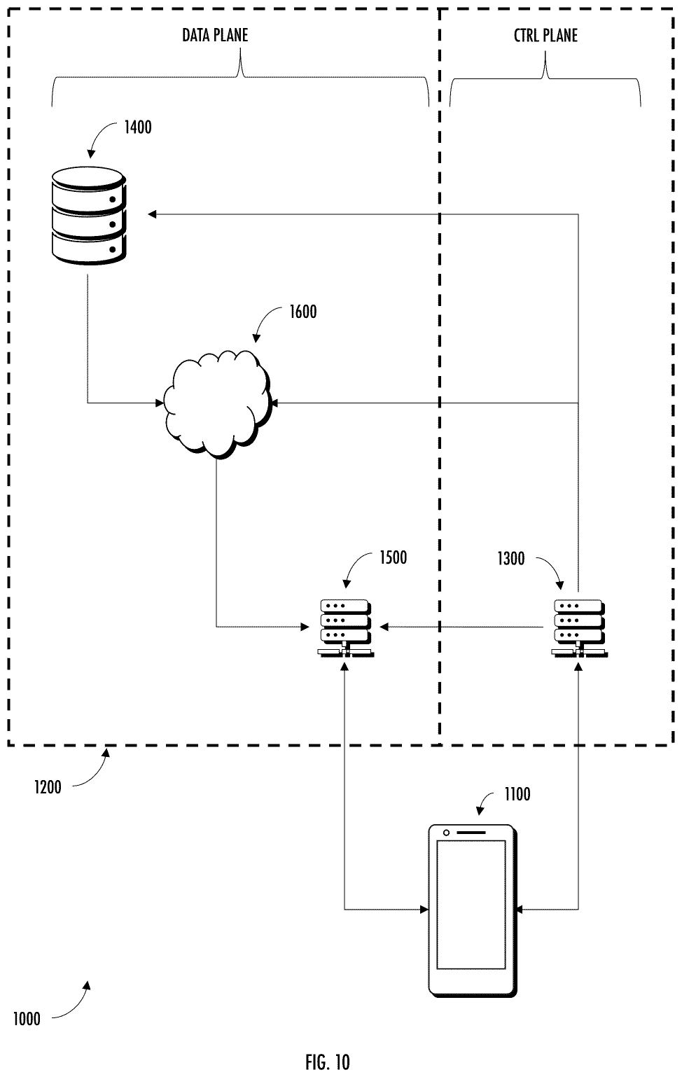

FIG. 10 is a logical block diagram of the exemplary system 1000 that includes: a media playback device 1100, and a media retrieval and delivery system 1200. During operation, the media playback device 1100 may request media for playback from the media retrieval and delivery system 1200. In some cases, the requested media may be streaming media that is generated “just-in-time” from archival media.

While the following discussion is presented in the context of a media playback device 1100 and a media retrieval and delivery system 1200, artisans of ordinary skill in the related arts will readily appreciate that the techniques may be broadly extended to other topologies and/or systems. For example, a CDN may transfer archival media to a user device that streams the media to another user device. As another example, content may be sourced from another cached location (e.g., a user's server) and routed through intermediaries to the user's edge server.

The following discussion provides functional descriptions for various logical entities of the exemplary system 1000. Artisans of ordinary skill in the related art will readily appreciate that other logical entities that do the same work in substantially the same way to accomplish the same result are equivalent and may be freely interchanged. A specific discussion of the structural implementations, internal operations, design considerations, and/or alternatives, for each of the logical entities of the exemplary system 1000 is separately provided below.

### Media Playback

Functionally, a media playback device 1100 plays media for a user. Examples of media playback devices include cellular phones, laptops, tablets, smart glasses, and/or other consumer electronics devices. Various other applications may be substituted with equal success by artisans of ordinary skill, given the contents of the present disclosure.

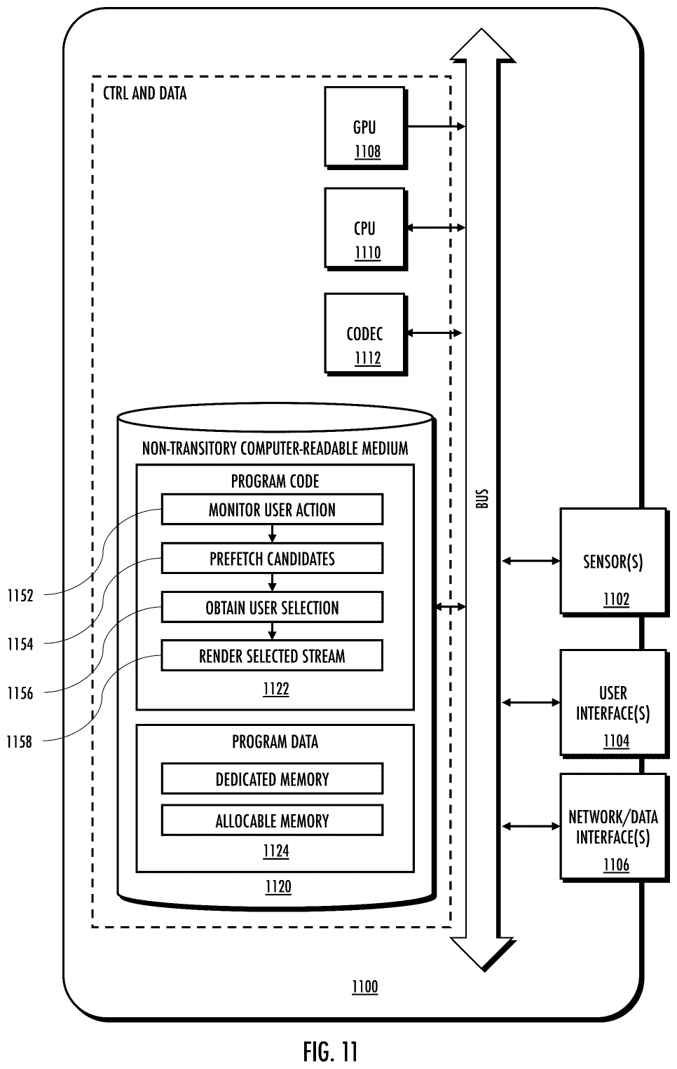

FIG. 11 is a logical block diagram of a media playback device 1100. The media playback device 1100 includes: a sensor subsystem 1102, a user interface subsystem 1104, a network/data interface subsystem 1106, a control and data subsystem and a bus to enable data transfer. The following discussion provides a specific discussion of the internal operations, design considerations, and/or alternatives, for each subsystem of the media playback device 1100.

Functionally, the sensor subsystem senses the physical environment and captures and/or records the sensed environment as data. In some embodiments, the sensor data may be stored as a function of capture time (so-called “tracks”). Tracks may be synchronous (aligned) or asynchronous (non-aligned) to one another. In some embodiments, the sensor data may be compressed, encoded, and/or encrypted as a data structure (e.g., MPEG, WAV, etc.)

In some embodiments, the sensor subsystem is an integral part of the media playback device 1100. In other embodiments, the sensor subsystem may be augmented by external devices and/or removably attached components (e.g., hot-shoe/cold-shoe attachments, etc.) The following sections provide detailed descriptions of the individual components of the sensor subsystem.

The sensor subsystem may include: a camera assembly, a microphone assembly, and an inertial measurement unit (IMU), etc. Other sensor subsystem implementations may multiply, combine, further sub-divide, augment, and/or subsume the foregoing functionalities within these or other subsystems. For example, two or more cameras may be used to capture panoramic (e.g., wide or) 360° or stereoscopic content. Similarly, two or more microphones may be used to record stereo sound, etc.

In one embodiment, a camera assembly includes a camera lens and a camera sensor. The camera lens bends (distorts) light to focus on the camera sensor. In one specific implementation, the optical nature of the camera lens is mathematically described with a lens polynomial. More generally however, any characterization of the camera lens' optical properties may be substituted with equal success; such characterizations may include without limitation: polynomial, trigonometric, logarithmic, look-up-table, and/or piecewise or hybridized functions thereof. In one variant, the camera lens provides a wide field-of-view greater than 90°; examples of such lenses may include e.g., panoramic lenses 120° and/or hyper-hemispherical lenses 180°. In one specific implementation, the camera sensor senses light (luminance) via photoelectric sensors (e.g., CMOS sensors). A color filter array (CFA) value provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image.

More generally however, the various techniques described herein may be broadly applied to any camera assembly; including e.g., narrow field-of-view (30° to) 90° and/or stitched variants (e.g., 360° panoramas). While the foregoing techniques are described in the context of perceptible light, the techniques may be applied to other EM radiation capture and focus apparatus including without limitation: infrared, ultraviolet, and/or X-ray, etc.

In one embodiment, a microphone assembly includes a microphone and a audio codec. The microphone senses acoustic vibrations and converts the vibrations to an electrical signal (via a transducer, condenser, etc.) The electrical signal may be further transformed to frequency domain information. The electrical signal is provided to the audio codec, which samples the electrical signal and converts the time domain waveform to its frequency domain representation. Typically, additional filtering and noise reduction may be performed to compensate for microphone characteristics. The resulting audio waveform may be compressed for delivery via any number of audio data formats.

Audio codecs generally fall into speech codecs and full spectrum codecs. Full spectrum codecs use the modified discrete cosine transform (mDCT) and/or mel-frequency cepstral coefficients (MFCC) to represent the full audible spectrum. Speech codecs reduce coding complexity by leveraging the characteristics of the human auditory/speech system to mimic voice communications. Speech codecs often make significant trade-offs to preserve intelligibility, pleasantness, and/or data transmission considerations (robustness, latency, bandwidth, etc.)

More generally however, the various techniques described herein may be broadly applied to any integrated or handheld microphone or set of microphones including, e.g., boom and/or shotgun-style microphones. While the foregoing techniques are described in the context of a single microphone, multiple microphones may be used to collect stereo sound and/or enable audio processing. For example, any number of individual microphones can be used to constructively and/or destructively combine acoustic waves (also referred to as beamforming).

The inertial measurement unit (IMU) includes one or more accelerometers, gyroscopes, and/or magnetometers. In one specific implementation, the accelerometer (ACCL) measures acceleration and gyroscope (GYRO) measure rotation in one or more dimensions. These measurements may be mathematically converted into a four-dimensional (4D) quaternion to describe the device motion, and electronic image stabilization (EIS) may be used to offset image orientation to counteract device motion (e.g., CORI/IORI). In one specific implementation, the magnetometer (MAGN) may provide a magnetic north vector (which may be used to “north lock” video and/or augment location services such as GPS), similarly the accelerometer (ACCL) may also be used to calculate a gravity vector (GRAV).

Typically, an accelerometer uses a damped mass and spring assembly to measure proper acceleration (i.e., acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both device direction and speed).

More generally, however, any scheme for detecting device velocity (direction and speed) may be substituted with equal success for any of the foregoing tasks. While the foregoing techniques are described in the context of an inertial measurement unit (IMU) that provides quaternion vectors, artisans of ordinary skill in the related arts will readily appreciate that raw data (acceleration, rotation, magnetic field) and any of their derivatives may be substituted with equal success.

Functionally, the user interface subsystem 1104 may be used to present media to, and/or receive input from, a human user. Media may include any form of audible, visual, and/or haptic content for consumption by a human. Examples include images, videos, sounds, and/or vibration. Input may include any data entered by a user either directly (via user entry) or indirectly (e.g., by reference to a profile or other source).

In some embodiments, the user interface subsystem 1104 is an integral part of the media playback device 1100. In other embodiments, the user interface subsystem may be augmented by external devices and/or removably attached components (e.g., hot-shoe/cold-shoe attachments, etc.) The following sections provide detailed descriptions of the individual components of the sensor subsystem.

The user interface subsystem 1104 may include: a touchscreen, physical buttons, and a microphone. In some embodiments, input may be interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

Other user interface subsystem implementations may multiply, combine, further sub-divide, augment, and/or subsume the foregoing functionalities within these or other subsystems. For example, the audio input may incorporate elements of the microphone (discussed above with respect to the sensor subsystem). Similarly, IMU based input may incorporate the aforementioned IMU to measure “shakes”, “bumps” and other gestures.

A touchscreen is an assembly of a touch-sensitive panel that has been overlaid on a visual display. Typical displays are liquid crystal displays (LCD), organic light emitting diodes (OLED), and/or active-matrix OLED (AMOLED). Touchscreens are commonly used to enable a user to interact with a dynamic display, this provides both flexibility and intuitive user interfaces. Within the context of mobile devices, touchscreen displays are especially useful because they can be sealed (waterproof, dust-proof, shock-proof, etc.)

Most commodity touchscreen displays are either resistive or capacitive. Generally, these systems use changes in resistance and/or capacitance to sense the location of human finger(s) or other touch input. Other touchscreen technologies may include, e.g., surface acoustic wave, surface capacitance, projected capacitance, mutual capacitance, and/or self-capacitance. Yet other analogous technologies may include, e.g., projected screens with optical imaging and/or computer-vision.

In some embodiments, the user interface subsystem 1104 may also include mechanical buttons, keyboards, switches, scroll wheels and/or other mechanical input devices. Mechanical user interfaces are usually used to open or close a mechanical switch, resulting in a differentiable electrical signal. While physical buttons may be more difficult to seal against the elements, they are nonetheless useful in low-power applications since they do not require an active electrical current draw. For example, many BLE applications may be triggered by a physical button press to further reduce GUI power requirements.

More generally, however, any scheme for detecting user input may be substituted with equal success for any of the foregoing tasks. While the foregoing techniques are described in the context of a touchscreen and physical buttons that enable user data entry, artisans of ordinary skill in the related arts will readily appreciate that any of their derivatives may be substituted with equal success.

Audio input may incorporate a microphone and codec (discussed above) with a speaker. As previously noted, the microphone can capture and convert audio for voice commands. For audible feedback, the audio codec may obtain audio data and decode the data into an electrical signal. The electrical signal can be amplified and used to drive the speaker to generate acoustic waves.

As previously noted, the microphone and speaker may have any number of microphones and/or speakers for beamforming. For example, two speakers may be used to provide stereo sound. Multiple microphones may be used to collect both the user's vocal instructions as well as the environmental sounds.

Functionally, the network/data interface subsystem 1106 may be used to transfer data to, and/or receive data from, external entities. The network/data interface subsystem 1106 is generally split into network interfaces and removeable media (data) interfaces. The network interfaces are configured to communicate with other nodes of a communication network according to a communication protocol. Data may be received/transmitted as transitory signals (e.g., electrical signaling over a transmission medium.) The data interfaces are configured to read/write data to a removeable non-transitory computer-readable medium (e.g., flash drive or similar memory media).

The illustrated network/data interface subsystem 1106 may include network interfaces including, but not limited to: Wi-Fi, Bluetooth, Global Positioning System (GPS), USB, and/or Ethernet network interfaces. Additionally, the network/data interface subsystem 1106 may include data interfaces such as: SD cards (and their derivatives) and/or any other optical/electrical/magnetic media (e.g., MMC cards, CDs, DVDs, tape, etc.)

The network/data interface subsystem 1106 may include one or more radios and/or modems. As used herein, the term “modem” refers to a modulator-demodulator for converting computer data (digital) into a waveform (baseband analog). The term “radio” refers to the front-end portion of the modem that upconverts and/or downconverts the baseband analog waveform to/from the RF carrier frequency.

The network/data interface subsystem 1106 may include wireless subsystems (e.g., 5^{th}/6^{th} Generation (5G/6G) cellular networks, Wi-Fi, Bluetooth (including, Bluetooth Low Energy (BLE) communication networks), etc.) Furthermore, the techniques described throughout may be applied with equal success to wired networking devices. Examples of wired communications include without limitation Ethernet, USB, PCI-e. Additionally, some applications may operate within mixed environments and/or tasks. In such situations, the multiple different connections may be provided via multiple different communication protocols. Still other network connectivity solutions may be substituted with equal success.

More generally, any scheme for transmitting data over transitory media may be substituted with equal success for any of the foregoing tasks.

The network/data interface subsystem 1106 of the media playback device 1100 may include one or more data interfaces for removeable media. In one exemplary embodiment, the media playback device 1100 may read and write from a Secure Digital (SD) card or similar card memory.

While the foregoing discussion is presented in the context of SD cards, artisans of ordinary skill in the related arts will readily appreciate that other removeable media may be substituted with equal success (flash drives, MMC cards, etc.) Furthermore, the techniques described throughout may be applied with equal success to optical media (e.g., DVD, CD-ROM, etc.).

More generally, any scheme for storing data to non-transitory media may be substituted with equal success for any of the foregoing tasks.

Functionally, the control and data processing subsystems are used to read/write and store data to effectuate calculations and/or actuation of the sensor subsystem, user interface subsystem, and/or network/data interface subsystem. While the following discussions are presented in the context of processing units that execute instructions stored in a non-transitory computer-readable medium (memory), other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As shown in FIG. 11, the control and data subsystem may include one or more of: a central processing unit (CPU 1110), a graphics processing unit (GPU 1108), a codec 1112, and a non-transitory computer-readable medium 1120 that stores program instructions and/or data. In some implementations, a neural network processing unit (not shown) may additionally be included for machine-learning applications.

As a practical matter, different processor architectures attempt to optimize their designs for their most likely usages. More specialized logic can often result in much higher performance (e.g., by avoiding unnecessary operations, memory accesses, and/or conditional branching). For example, a general-purpose CPU (such as shown in FIG. 11) may be primarily used to control device operation and/or perform tasks of arbitrary complexity/best-effort. CPU operations may include, without limitation: general-purpose operating system (OS) functionality (power management, UX), memory management, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks, and must account for branch disruption and/or arbitrary memory access.

The GPU is primarily used to modify image data and may be heavily pipelined (seldom branches) and may incorporate specialized vector-matrix logic. The GPU often performs image processing acceleration for the CPU, thus the GPU may need to operate on multiple images at a time and/or other image processing tasks of arbitrary complexity. In many cases, GPU tasks may be parallelized and/or constrained by real-time budgets. GPU operations may include, without limitation: stabilization, lens corrections (stitching, warping, stretching), image corrections (shading, blending), noise reduction (filtering, etc.). GPUs may have much larger addressable space that can access both local cache memory and/or pages of system virtual memory. Additionally, a GPU may include multiple parallel cores and load balancing logic to e.g., manage power consumption and/or performance. In some cases, the GPU may locally execute its own operating system to schedule tasks according to its own scheduling constraints (pipelining, etc.).

The hardware codec converts image data to an encoded data for transfer and/or converts encoded data to image data for playback. Hardware codecs are often designed according to specific use cases and heavily commoditized. Typical hardware codecs are heavily pipelined, may incorporate discrete cosine transform (DCT) logic (which is used by most compression standards), and often have large internal memories to hold multiple frames of video for motion estimation (spatial and/or temporal). Codecs are often bottlenecked by network connectivity and/or processor bandwidth, thus codecs are seldom parallelized and may have specialized data structures (e.g., registers that are a multiple of an image row width, etc.). In some cases, the codec may locally execute its own operating system to schedule tasks according to its own scheduling constraints (bandwidth, real-time frame rates, etc.).

As a practical matter, a hardware codec is a single block that includes encoder and decoder logic. Typically, both encoder and decoder logic have physically dedicated logic but may also share common hardware (e.g., DMA channels, etc.). Some implementations may allow portions of the logic to be independently powered (e.g., an encoder-only mode, a decoder-only mode, etc.); other implementations may provide more fine-grained control e.g., enabling specific data and/or control paths, etc. A single codec may support multiple different media formats (e.g., H264, H265, HEVC, etc.) by adjusting the encoding/decoding parameters. More generally, artisans of ordinary skill in the related arts will readily appreciate that a “codec” may refer to any codec-like logic. A codec may refer to a hardware codec, a software codec (designed to emulate the functionality of a hardware codec), and/or any functional portion thereof (e.g., an encoder, decoder, etc.).

As used herein, the term “real-time” refers to tasks that must be performed within definitive constraints; for example, a video camera must capture each frame of video at a specific rate of capture (e.g., 30 frames per second (fps)). As used herein, the term “near real-time” refers to tasks that must be performed within definitive time constraints once started; for example, a smart phone may use near real-time rendering for each frame of video at its specific rate of display, however some queueing time may be allotted prior to display.

Unlike real-time tasks, so-called “best-effort” refers to tasks that can be handled with variable bit rates and/or latency. Best-effort tasks are generally not time sensitive and can be run as low-priority background tasks (for even very high complexity tasks), or queued for cloud-based processing, etc.

Other processor subsystem implementations may multiply, combine, further sub-divide, augment, and/or subsume the foregoing functionalities within these or other processing elements. For example, multiple ISPs may be used to service multiple camera sensors. Similarly, codec functionality may be subsumed with either GPU or CPU operation via software emulation.

In one embodiment, the memory subsystem may be used to store data locally at the media playback device 1100. In one exemplary embodiment, data may be stored as non-transitory symbols (e.g., bits read from non-transitory computer-readable mediums.) In one specific implementation, the memory subsystem including non-transitory computer-readable medium 1120 is physically realized as one or more physical memory chips (e.g., NAND/NOR flash) that are logically separated into memory data structures. The memory subsystem may be bifurcated into program code 1122 and/or program data 1124. In some variants, program code and/or program data may be further organized for dedicated and/or collaborative use. For example, the GPU and CPU may share a common memory buffer to facilitate large transfers of data therebetween. Similarly, the codec may have a dedicated memory buffer to avoid resource contention.

In some embodiments, the program code may be statically stored within the media playback device 1100 as firmware. In other embodiments, the program code may be dynamically stored (and changeable) via software updates. In some such variants, software may be subsequently updated by external parties and/or the user, based on various access permissions and procedures.

Historically, machine-learning logic was often implemented as large vector-matrix operations which can be performed on specialized vector-matrix logic (such as might be found in the GPU). More recently, however, machine-learning logic may be implemented as a wholly separate logic specifically for accelerating neural network computations. Typically, the NPU includes hardware acceleration for highly parallelized matrix multiplication and non-linear processing (for activation functions).

Unlike traditional “Turing”-based processor architectures (discussed above), neural network processing emulates a network of connected nodes (also known as “neurons”) that loosely model the neuro-biological functionality found in the human brain. While neural network computing is still in its infancy, such technologies already have great promise for e.g., compute rich, low power, and/or continuous processing applications.

Each processor node of the neural network is a computation unit that may have any number of weighted input connections, and any number of weighted output connections. The inputs are combined according to a transfer function to generate the outputs. In one specific embodiment, each processor node of the neural network combines its inputs with a set of coefficients (weights) that amplify or dampen the constituent components of its input data. The input-weight products are summed and then the sum is passed through a node's activation function, to determine the size and magnitude of the output data. “Activated” neurons (processor nodes) generate output data. The output data may be fed to another neuron (processor node) or result in an action on the environment. Coefficients may be iteratively updated with feedback to amplify inputs that are beneficial, while dampening the inputs that are not.

Many neural network processors emulate the individual neural network nodes as software threads, and large vector-matrix multiply accumulates. A “thread” is the smallest discrete unit of processor utilization that may be scheduled for a core to execute. A thread is characterized by: (i) a set of instructions that is executed by a processor, (ii) a program counter that identifies the current point of execution for the thread, (iii) a stack data structure that temporarily stores thread data, and (iv) registers for storing arguments of opcode execution. Other implementations may use hardware or dedicated logic to implement processor node logic.

As used herein, the term “emulate” and its linguistic derivatives refers to software processes that reproduce the function of an entity based on a processing description. For example, a processor node of a machine learning algorithm may be emulated with “state inputs”, and a “transfer function”, that generate an “action.”

Unlike the Turing-based processor architectures, machine learning algorithms learn a task that is not explicitly described with instructions. In other words, machine learning algorithms seek to create inferences from patterns in data using e.g., statistical models and/or analysis. The inferences may then be used to formulate predicted outputs that can be compared to actual output to generate feedback. Each iteration of inference and feedback is used to improve the underlying statistical models. Since the task is accomplished through dynamic coefficient weighting rather than explicit instructions, machine learning algorithms can change their behavior over time to e.g., improve performance, change tasks, etc.

Typically, machine learning algorithms are “trained” until their predicted outputs match the desired output (to within a threshold similarity). Training may occur “offline” with batches of prepared data or “online” with live data using system pre-processing. Many implementations combine offline and online training to e.g., provide accurate initial performance that adjusts to system-specific considerations over time. Once the NPU has “learned” appropriate behavior, the NPU may be used in real-world scenarios. NPU-based solutions are often more resilient to variations in environment and may behave reasonably even in unexpected circumstances (e.g., similar to a human.)

While the following discussions are presented in the context of a Turing-based processor-memory configuration, neural network and/or machine learning may be substituted with equal success by artisans of ordinary skill in the related arts.

### User Action-Based Prefetching

Various aspects of the present disclosure are directed to user action-based prefetching. As shown in FIG. 11, the non-transitory computer-readable medium includes a routine that obtains media for playback. When executed by the control and data subsystem, the routine causes the media playback device to: monitor user actions, prefetch candidate media based on detected actions, obtain a user selection of media, and render the selected media.

At step 1152, the media playback device monitors for user actions. Here, “user actions” may include both active interactions between the user and the device as well as passive user activity that is monitored by the device. For example, the media playback device 1100 may monitor active navigation (e.g., scrolling through media, navigating a file system, etc.) as well as indications of user interest and/or activity (e.g., eye-tracking, movement, etc.).

In one exemplary embodiment, user actions are navigation-based. User interface navigation refers to the methods and mechanisms through which users interact with and move within a media library. This includes touch-based scrolling, menus, links, buttons, search bars, and other interactive elements that guide users to different media. User interface navigation may indicate user interest by tracking how users interact with different elements, which paths they take, and how much time they spend on specific sections. Notably, certain users may navigate their media in a manner which may further improve prediction success. For example, a person that thinks chronologically is likely to search chronologically (e.g., narrowing in on year, month, week, day, etc.). Similarly, users that think thematically may search using thematic labels (e.g., narrowing by album, events, location, people, etc.).

More broadly, artisans of ordinary skill in the related arts will readily appreciate that any user actions and/or combination of user actions that are predictive of a subsequent request for content may be substituted with equal success. User actions that predict user interest may include e.g., viewing behavior (eye-tracking), previous viewing history, viewing location/time, etc. For example, a person that is scrolling through their media may fixate on media that is particularly interesting. Sometimes a user that watches one video, may want to look at related media, etc. Similarly, users may view certain types of media in certain locations and/or at certain times (e.g., editing is always done at the home office whereas live streaming may be viewed elsewhere, etc.). Some devices may implement spatial processing where media playback is associated with spatial locations e.g., smart glasses/goggles may have a virtual video frame or similar spatially anchored media.

Here, monitoring generally refers to mechanisms for tracking user actions with the media playback device to predict future user input. This can involve collecting data on user actions, such as scrolling, clicks, keystrokes, navigation paths, time spent on various sections, etc. In some embodiments, the prediction may be based on a set of conditions e.g., scrolling is slowing, navigation is narrowing, etc. In other embodiments, prediction may be dynamically determined e.g., based on machine-learning analysis, etc.

In one embodiment, a set of candidate media is predicted from user actions. The candidate set refers to an inferred set of potential options or choices that are under consideration for media playback. Typically, the user will perform actions that progressively narrow their media library down to a smaller pool of candidates before making their final selection. For example, a user will quickly scroll past the majority of their media library before slowing, and eventually stopping, on the portion of their mural that includes the clip of interest; then the user selects media for playback. Here, the candidate pool may be the set of media identified by the portion of the mural where scrolling slowed/stopped. More generally, any user action that progressively narrows the media library to progressively smaller pools of candidates may predict a higher likelihood of a hit (subsequent selection) than user actions that have an uncorrelated scope.

At step 1154, the media playback device prefetches candidate media based on the monitored user actions. Anticipatory and/or eager behavior may be balanced to accommodate considerations of both the media playback device as well as the content delivery network. While strongly predictive user actions may avoid misses, they may not provide enough advance notice to sufficiently prefetch content; weaker predictors may provide larger latency reductions (and better user experience) at higher miss rates.

As used herein, the term “anticipate” and its linguistic derivatives refers to actions taken to prepare for an explicit request that has not yet occurred. Examples of anticipatory behavior may include e.g., prediction, prefetching, speculative execution, and/or any other preemptive processing.

As used herein, the term “eager” and its linguistic derivatives refers to task scheduling that prioritize task execution based on the availability of input data. In contrast, “lazy” and its linguistic derivatives refer to task scheduling that defer task execution until output data is needed. Conceptually, eager scheduling prioritizes latency, whereas lazy scheduling prioritizes efficiency. Artisans of ordinary skill will readily appreciate that eagerness/laziness may lay on a spectrum; task scheduling algorithms may weigh both considerations in determining scheduling. In other words, a more eager scheduler may prioritize availability of input data over output data timing; a lazier scheduler may prioritize output data timing over input data availability.

Here, prefetching pre-warms the edge server with the candidate set; this greatly reduces latency for any media that is subsequently selected from the candidate set. “Eager” edge servers (discussed in greater detail below) may pre-warm, even without transferring data. However, most conventional edge servers implement “lazy” caching—a lazy edge server may only cache data for non-zero data transfers. In such variants, the media playback device may download portions of the prefetched candidate media to force a lazy edge server to pre-warm. Depending on implementation, these prefetched portions may be locally cached at the device in preparation for playback or ignored/discarded (storing the prefetched portions may save a little bandwidth, but latency is no longer an issue since the pre-warmed segments may be immediately re-downloaded).

In one specific implementation, prefetching may include downloading a manifest and/or one or more segments of media. In some cases, the number of segments of media may be enough to buffer streaming for current network conditions. For example, an uncongested network may only need a few segments (1-3) to effectively buffer for network delays; a highly congested network may need more segments (4-10, etc.) to ensure reliable buffering. In some embodiments, the prefetched segments may be cached for each of the candidates; e.g., if there are 4 candidates then 4 streams are prefetched, if there are 9 candidates then 9 streams are prefetched etc. In some cases, the prefetched segments may use a reduced resolution (e.g., 480p) to minimize transfer size; this may be particularly useful for media retrieval and delivery systems that transmultiplex/transcode at the edge server since the full resolution media is pre-warmed even for low resolution delivery. In other words, the prefetched segment at lower resolution serves to pre-warm the cache for any playback resolution.

In specific embodiment, the media playback device may execute one or more agents. As used herein, the term “agent” and its linguistic derivatives refers to any software application that acts on behalf of an entity, in interactions with another entity. A “user” agent may act on behalf of a user, a “kernel” agent may act on behalf of the device kernel, etc. Within most network implementations, a network identifier (e.g., an Internet Protocol (IP) address) may be associated with multiple agent identifiers which correspond to different program instances (e.g., a user agent string). In one specific implementation, the media playback device may use one agent to handle user requests (e.g., a player agent, a rendering agent, an editing agent, etc.), and one or more agents that speculatively prefetch data based on user action (e.g., navigation, etc.). As but one such example, a player agent may service explicit user requests, whereas a prefetch agent may proactively take action (unbeknown to the user) based on likelihood of interest inferred from user activity.

In some embodiments, a media playback device may include multiple prefetch agents. This may be particularly useful where there are multiple different modalities of candidate selection which may be concurrently happening. For example, a smart phone might track user navigation with a first prefetch agent, while smart glasses may concurrently monitor eye-tracking information with a second prefetch agent; here, both devices may be connected to the same edge server via the same IP address (e.g., where the smart glasses are tethered to, and share, the smart phone connection). More generally, however, any scheme for associating agents together may be substituted with equal success.

At step 1156, the media playback device obtains a user selection and then renders the selected stream at step 1158. In one exemplary embodiment, the user selects a video clip for HLS (HTTP Live Streaming) segment streaming. The HLS protocol uses a manifest file to index and organize these segments, listing the URLs for each segment and the different quality versions. The media playback device continuously monitors network conditions and switches between different bitrate segments to provide the best possible viewing experience for network conditions. In some embodiments, the media playback device uses its locally prefetched manifest and segments to start the playback further reducing latency; in other embodiments, the media playback device downloads a pre-warmed manifest then obtains segments.

While the foregoing discussion is presented in the context of sequential downloads, the concepts may be readily extended to non-sequential playback. For example, a user may want to play clips from a highlight point, rather than the first segment. Other schemes may allow a person to virtually piece-together replays using different segments—in some cases, segments may be taken from different media to provide a video “collage” effect. More generally, artisans of ordinary skill in the related arts will appreciate that any playback order may be substituted with equal success.

Consider, for instance, a highlight reel where exciting points are not chronologically ordered. Here, a user that selects a particular media clip may immediately want to skip to the most exciting point, etc. Instead of prefetching the segments in chronological order, the segments may be prefetched at highlight(s). In fact, highlight reel viewing may automatically “lead-into” another media data structure-here, starting a first media playback at a first highlight may be used to automatically trigger prefetching of the next media file with the next highlight, etc. Still other variations of the foregoing may be substituted with equal success by artisans of ordinary skill in the arts, given the contents of the present disclosure.

While the foregoing examples are discussed in the context of HLS, these concepts may be broadly extended to other progressive download technologies. For example, HTTP progressive download is commonly used with websites and enables a media player to begin playback once enough data has been buffered, while the rest of the file continues to download in the background. Other examples include HTML5 as well as proprietary players (e.g., Apple QuickTime, RealNetworks Realplayer, Adobe Flash, etc.).

### Media Retrieval and Delivery

Functionally, a media retrieval and delivery system stores media and retrieves the media when requested. Certain use cases may impose requirements (e.g., timing, distribution, etc.) on media playback. Since these requirements may affect the delivery operation, the media retrieval and delivery system may also manage delivery of the media from storage.

The media retrieval and delivery system may be implemented as a content delivery network (CDN) that is handled within a “cloud service”. Cloud services refer to software services that can be provided from remote data centers. Typically, datacenters include resources, a routing infrastructure, and network interfaces. The datacenter's resource subsystem may include its servers, storage, and scheduling/load balancing logic. The routing subsystem may be composed of switches and/or routers. The network interface may be a gateway that is in communication with the broader internet. The cloud service provides an application programming interface (API) that “virtualizes” the data center's resources into discrete units of server time, memory, space, etc. During operation, a client requests media that causes the cloud service to e.g., route media from a first storage (bulk archival) to an edge server to handle delivery requirements (e.g., closer to the user for on-time delivery, etc.).

Referring first to the resource management subsystem, the data center has a number of physical resources (e.g., servers, storage, etc.) that can be allocated to handle service requests. Here, a server refers to a computer system or software application that provides services, resources, or data to other computers, known as clients, over a network. In most modern cloud compute implementations, servers are distinct from storage—e.g., storage refers to a memory footprint that can be allocated to a service.

Within the context of the present disclosure, data center resources may refer to the type and/or number of processing cycles of a server, memory footprint of a disk, data of a network connection, etc. For example, a server may be defined with great specificity e.g., instruction set, processor speed, cores, cache size, pipeline length, etc. Alternatively, servers may be generalized to very gross parameters (e.g., a number of processing cycles, etc.). Similarly, storage may be requested at varying levels of specificity and/or generality (e.g., size, properties, performance (latency, throughput, error rates, etc.)). In some cases, bulk storage may be treated differently than on-chip cache (e.g., L1, L2, L3, etc.).

Referring now to the routing subsystem, this subsystem connects servers to clients and/or other servers via an interconnected network of switches, routers, gateways, etc. A switch is a network device that connects devices within a single network, such as a LAN. It uses medium access control (MAC) addresses to forward data only to the intended recipient device within the network (Layer 2). A router is a network device that connects multiple networks together and directs data packets between them. Routers typically operate at the network layer (Layer 3).

Lastly, the network interface may specify and/or configure the gateway operation. A gateway is a network device that acts as a bridge between different networks, enabling communication and data transfer between them. Gateways are particularly important when the networks use different protocols or architectures. While routers direct traffic within and between networks, gateways translate between different network protocols or architectures—a router that provides protocol translation or other services beyond simple routing may also be considered a gateway.

Conceptually, cloud services access, reserve, and use physically remote computing resources (e.g., processing cycles, memory, data, applications, etc.) with different degrees of physical hardware and/or infrastructure management. Modern data centers handle many different cloud services from a myriad of different entities—it's not uncommon for data centers to have average utilizations north of 60% (which compares favorably to the average utilization (<1%) for dedicated servers infrastructures). Computational efficiencies are directly passed onto the cloud service as operational cost; in other words, cloud services are only charged for the resources that they request.

Cloud services are often leveraged to reduce the resource burden for embedded devices-processing intensive and/or best effort tasks can be handled in the cloud. However, efficient usage of cloud services often requires different design considerations from embedded devices. For example, cloud services benefit from careful resource allocation; over-allocation, under-allocation, and/or any other type of mis-allocation can be very inefficient (too much idle time, excessive resource churn, etc.). In contrast, embedded devices are physically constrained and cannot be virtually scaled. Thus, embedded devices are often conservatively designed to match its e.g., most likely use cases, worst case use cases, etc. Embedded devices offer significant performance enhancements and/or security relative to cloud-based counterparts. For comparison, once configured, inter-data center communication is ˜10× slower than intra-data center communication, which is ˜10× slower than on-device communication.

Due to the virtualized nature of cloud services, logical entities are often described in terms of their constituent services, rather than their physical implementation. In the illustrated embodiment of FIG. 10, the media retrieval and delivery system 1200 may be bifurcated into a control plane and a data plane. The control plane configures and manages the system operations to effectuate the delivery. The data plane delivers media as controlled by the control plane. In one exemplary embodiment, the control plane includes a web server (or other network interface) that provides a front-end API 1300 to request media; the data plane is implemented as media storage 1400 (e.g., origin server) and a distribution network 1500 (e.g., edge servers). Some implementations may additionally incorporate processing and/or routing resources 1600 (e.g., intermediary data centers, etc.).

An API (Application Programming Interface) is a set of rules and protocols that allows different software applications to communicate and interact with each other. It defines the methods, data formats, and conventions that enable access to, and functionality of, a software service, library, or platform. The illustrated implementation includes a front-end API that may be accessed by a media playback device. The front-end APIs are used by the media playback device to request media delivery according to a specific protocols and formats (e.g., streaming delivery, progressive download, bulk file download, etc.).

Media storage 1400 is configured to store and retrieve media. In one specific embodiment, media storage 1400 is designed to provide cost-effective archival (e.g., prioritizing durability and security over accessibility). As a practical matter, this may leverage the benefits of specific data structure formats (e.g., MPEG-4 compressed files, etc.). While the illustrated embodiment shows a single media storage, artisans of ordinary skill in the related arts will readily appreciate that physical implementations may be spread across many storage apparatus—for example, most cloud based storage is implemented with a RAID (Redundant Array of Independent Disks) array. RAID arrays are a data storage virtualization technology that combines multiple physical disk drive components into a single logical unit for improved performance, redundancy, or both. RAID arrays can be configured in various levels, such as RAID 0, RAID 1, RAID 5, RAID 6, and RAID 10, each offering distinct benefits and trade-offs. RAID 0, for instance, focuses on performance enhancement by striping data across multiple disks but lacks redundancy. RAID 1 provides data mirroring for redundancy, ensuring data is duplicated across two disks. RAID 5 and RAID 6 add parity information to the striping process, allowing for data recovery in the event of one or two disk failures, respectively. RAID 10 combines the features of RAID 0 and RAID 1 by striping and mirroring data, delivering high performance and redundancy. RAID arrays are commonly used in enterprise environments and data centers to safeguard against data loss, improve data access speeds, and ensure continuous data availability.

A distribution network 1500 is configured to deliver media in response to user requests. In one specific embodiment, the distribution network 1500 includes one or more servers and storage that are designed to deliver media within usage constraints (e.g., prioritizing accessibility and reliability over compression, etc.). As a practical matter, this may require conversion to specific data structure formats (e.g., MPEG-2 transport stream encapsulation, manifest-based delivery, etc.). While the illustrated embodiment shows a single server, artisans of ordinary skill in the related arts will readily appreciate that physical implementations of a distribution network are implemented as multiple servers that are geographically distributed to optimize for physical proximity (which reduces transport delay and network routing). In some implementations, user generated content is delivered from the edge server that is best suited to handle the user request-however other implementations may consider other factors e.g., server availability, user priority, usage scenario, load balancing, scalability, reliability/redundancy, security, etc.

Some media retrieval and delivery systems may additionally include additional processing and/or routing resources 1600. These resources may include e.g., additional resources (servers, processors, storage, etc.), routers, gateways, etc. that may be dynamically incorporated within the system operation. For example, additional processors may be used to e.g., convert and/or transmultiplex/transcode data from one format to another. Still other implementations may multiply, combine, further sub-divide, augment, and/or subsume the foregoing functionalities within these or other subsystems.

As a brief aside, streaming protocols (HTTP Live Streaming (HLS), MPEG-DASH, etc.) are designed for content delivery networks that service large populations of users (mass media delivery). Existing HLS implementations offload media playback state to the client device, i.e., the client device uses the master playlist to identify the appropriate URL corresponding to the current playback location in the media. Existing HLS servers do not parse the media files, they merely service URL addresses where pre-segmented HTTP-based segment downloads can be reached, without current playback state.

As used herein, the term “state” and “stateful” refer to protocols that maintain an ongoing status. Stateful protocols require both the client and the server to remember their status. For example, if a client requests stateful media playback, the server must track the client's current playback progress. In contrast, “stateless” protocols do not require the server to retain session information or a status.

Notably, unlike mass media CDNs, user-generated content is relatively infrequent and thus stateful communication is a comparatively low burden. Furthermore, stateful playback may offer certain benefits which may outweigh the costs of stateful operation. Such benefits may include e.g., session persistence, personalization, consistency, efficient re-use of previously downloaded data, etc. Thus, media retrieval and delivery systems may implement either stateless or stateful protocols.

### “Eager” Pre-Warming

Most content delivery networks (CDNs) “lazily” address requests for uncached data-origin server accesses are deferred until data transfer is necessary. In contrast, various aspects of the present disclosure are directed to “eager” pre-warming of the media retrieval and delivery system.

Here, the term “pre-warming” and its linguistic derivatives refers to operations that populate a cache with data before it is requested by the user. Pre-warming improves the performance and response times of applications or systems by ensuring that the pre-warmed data is readily available (cached) before a playback request is received. While the foregoing discussion was presented in the context of a CDN network, the concepts may be broadly extended to any performance bottleneck that may benefit from pre-warming. For example, a home media server may pre-warm its local cache to serve potential requests via a wireless local area network (WLAN). As another such example, a workstation may pre-warm its local cache to speed up a potential rendering.

In one specific implementation, eager “transfer-less” pre-warming may be configured via the control plane to prepare the data plane for transfer, without transferring media to the media playback device. In other words, the media may be transferred within the media retrieval and delivery system (e.g., from the origin server to the edge server, via the intermediary data centers), but the edge transfer may be deferred until a user request is made. Transfer-less pre-warming may be contrasted with transfer pre-warming that exercises the media transfer from end-to-end i.e., the media may be transferred from the media retrieval and delivery system to the media playback device. Notably, transfer-less pre-warming conserves edge resources (avoiding network congestion, reducing power consumption, etc.).

In one specific embodiment, the media retrieval and delivery system may enable just-in-time delivery. Just-in-time delivery may include delivery of streamable assets and/or quasi-streamable assets. As discussed elsewhere, quasi-streamable assets may be stored in an archival format (e.g., MPEG-4) but delivered in a streaming format (e.g., MPEG-2 transport streams via HTTP Live Streaming (HLS)). Here, eager pre-warming may perform the additional steps of creating a non-existent file structure and/or transmultiplexing/transcoding. Depending on implementation, these additional steps may be performed within the intermediary data structure, the edge server, and the origin server.

As used herein, the terms “on-the-fly” and/or “just-in-time” refer to logic, functionality, and/or operations that are performed responsive to a request, rather than prepared in-advance. Within the context of the present disclosure, prefetching and other speculative execution may be initiated based on likelihood of interest inferred from user activity-here, pre-warming occurs, but not media playback (and streaming delivery may also be deferred). In other words, “just-in-time” delivery refers to the streaming delivery and media playback that occurs from the pre-warmed caches, triggered by user request.

As shown in FIG. 10, the media retrieval and delivery system may be configured to: obtain candidate selections for prefetching, prefetch the candidate selections, pre-warm the candidate media for delivery, and deliver a selected media from the candidate media based on a user request.

As discussed elsewhere, candidate selections may be received from a media playback device via the front-end API 1300. More generally, however, candidate selection of sufficient predictive value (e.g., as measured by a threshold, previous history, other predictive metric, etc.) may be received from any entity. Control plane processing may be handled at the front-end API 1300 or via another entity. For example, the origin server may identify candidates that are commonly viewed after a user selection for pre-warming. For example, a user watching snowboarding videos from their media library may jump around between different snowboarding adventures. Similarly, external 3^{rd} parties that have access to a user's viewing history may provide media suggestions. For example, a user watching snowboarding videos from their media library may receive advertising thumbnails for other ski resorts, related media from their friend's media library, etc. Pre-warming these related media clips can further enrich the user's engagement with their own content.

In some embodiments, the candidate selections may be further modified by the front-end API 1300 or via another entity of the media retrieval and delivery system. For example, an overly eager prefetch agent may provide a much larger list of candidates than the network can currently supply; a smaller subset of candidates may be prefetched to provide a more conservative (less eager) prefetch. Similarly, a media playback device may not have full information about a user's interest—a user may be viewing videos based on their friend's recommendations, etc. Here, the media retrieval and delivery system may augment the selected candidates to include selections from other information. More generally, candidate selections may be added, removed, swapped/substituted, and/or combined with other candidates with equal success.

The media playback device may have information about the user but may not have visibility into the system-wide considerations (e.g., network congestion, processing load, resource allocation, etc.). There may be any number of reasons to modify the candidate selection in view of the system capabilities. For example, the control plane of the media retrieval and delivery system may balance user requests against network considerations before initiating the prefetching/pre-warming process. Similarly, the control plane may make any number of decisions regarding now the media should be served, processed, routed, etc. Examples of such decisions may include routing path (from origin server to edge server to media playback device), supported formats (streamable/quasi-streamable), policy enforcement (authorization, authentication, etc.), and/or any number of other system considerations.

While the foregoing examples are presented in the context of “pushed” candidate selection, “pulled” candidate selection may be substituted with equal success. For example, the front-end API 1300 of the media retrieval and delivery system may monitor existing network operation (congestion, processing burden, etc.) and determine the number of candidates that may be prefetched (e.g., 4, 9, 16, etc.). This number may be provided to the media playback device via the front-end API 1300; the media playback device may provide candidate selection up to (but not exceeding) that number, etc.

Once candidates are selected, the control plane configures the data plane to deliver the candidates to the distribution network 1500. In one embodiment, the media playback device requests and receives media via a single network (IP) address. While the simplest implementations may associate a single network address to a single media playback device that is served by a single edge server, more complicated network connectivity may be substituted with equal success (e.g., multiple network addresses, media playback devices, and/or edge servers). For example, smart glasses may track user interest (eye-tracking) while browsing a media library on a smart phone; here, the user interest may be used to identify candidates for delivery to the smart phone (on a different IP address).

In some embodiments, pre-warming may entail processing of the candidate selections. As a brief aside, “prefetch” and “pre-warm” refer to related but distinct concepts. Prefetching refers to techniques that load data into a cache based on expected future requests (the fetch). Pre-warming refers to techniques that initialize a process in preparation for (but outside of) run-time processing-colloquially akin to warming up an engine, etc. Prefetching and pre-warming may refer to the same or different mechanisms; prefetching techniques are not always pre-warming and vice versa. As but one such example, “prefetching” the archival media to the edge server and “pre-warming” the transmultiplexing/transcoding may be treated as a single step in some implementations. Other implementations may distinguish between these processes; e.g., media may be prefetched without pre-warming transmultiplexing/transcoding until quasi-streaming functionality is needed.

Pre-warming may include configuring transmultiplexing/transcoding logic for just-in-time delivery; this logic may be implemented within the distribution network 1500 (e.g., at an edge server) or processing and/or routing resources 1600 (e.g., intermediary data centers, etc.). Transmultiplexing and transcoding for just-in-time delivery is discussed in greater detail within U.S. patent application Ser. No. 17/320,503 filed May 14, 2021, and entitled “METHODS AND APPARATUS FOR JUST-IN-TIME STREAMING MEDIA”, incorporated by reference in its entirety. Within the context of the present disclosure, transmultiplexing and transcoding refer to two related, but distinct processes. Transmultiplexing re-packages or re-packetizes media files into different delivery formats without changing the files' contents; e.g., MPEG-4 to MPEG-2 transport streams, etc. In contrast, transcoding decodes media in a first format and re-encodes into a second format that is suitable for the desired application. Transcoding may be more computationally expensive than transmuxing but may allow for more flexibility and/or support over a wider range of applications.

As described elsewhere, candidates are speculative in nature; excessive pre-warming may be wasteful whereas conservative pre-warming may not provide enough performance. In one specific embodiment, candidate selections are pre-warmed to buffer for delivery latency. In some cases, this may be a static or semi-static amount of buffering; e.g., 2-3 segments of video may be enough for most network conditions. In other embodiments, this may dynamically consider factors such as e.g., ongoing network congestion, resource utilization, historic usage, etc.

Some implementations may modify the amount of pre-warming based on likelihood/confidence. For example, confident candidates may pre-warm 4-5 segments buffered, less confident candidates may pre-warm 2-3 segments. Still other variants may provide different levels of pre-warming; high confidence candidates may enable both streamable and quasi-streamable assets, low confidence candidates may only enable streamable assets, etc. More broadly, pre-warming strategies may be modified to suit any number of different system considerations.

In some embodiments, pre-warming may be “transfer-less”—as previously noted, transfer-less pre-warming prepares the data plane for delivery, without transferring media to the media playback device. In other embodiments, transfer pre-warming may include transferring media to the media playback device.

At a later time, the distribution network 1500 delivers selected media based on a user request. In stateful embodiments, the distribution network 1500 may independently track agent activity. This may be useful to differentiate between prefetch agents and player agents; for example, in some cases, the distribution network 1500 may track pre-warmed media segments that were transferred during pre-warming; this may be used to avoid re-transmission. In other cases, state may be entirely tracked at the media playback device (i.e., segments are served regardless of whether they were previously requested).

In addition, state information may be used to determine how accurate prefetch agents are in predicting subsequent player agents. A successful prefetch agent may allow for more aggressive pre-warming; however, the prefetch agent may be notified once misses begin to occur, etc.

### Additional Configuration Considerations

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein any reference to any of “one embodiment” or “an embodiment”, “one variant” or “a variant”, and “one implementation” or “an implementation” means that a particular element, feature, structure, or characteristic described in connection with the embodiment, variant or implementation is included in at least one embodiment, variant or implementation. The appearances of such phrases in various places in the specification are not necessarily all referring to the same embodiment, variant or implementation.

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

As used herein, the terms “camera” or “image capture device” may be used to refer without limitation to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus, comprising:
a user interface;
a network interface;
a processor; and
a non-transitory computer-readable medium comprising instructions that when executed by the processor, cause the processor to:
monitor user action;
determine a set of candidate media based on the user action; and
prefetch the set of candidate media via the network interface.

2. The apparatus of claim 1, where the user interface is configured to display a mural of media, and where the user action comprises a scroll rate through the mural.

3. The apparatus of claim 1, where the instructions further cause the processor to:
obtain a user selection for a selected media via the user interface; and
responsive to the user selection, request the selected media.

4. The apparatus of claim 3, where the set of candidate media is prefetched via a prefetch agent and the selected media is requested via a player agent.

5. The apparatus of claim 4, where segments of the set of candidate media are locally cached.

6. The apparatus of claim 5, where at least a portion of the selected media is obtained from a locally cached segment.

7. The apparatus of claim 1, where the set of candidate media is transfer-lessly prefetched.

8. A system, comprising:
data plane logic comprising a media storage and a distribution network; and
control plane logic comprising an application programming interface, the control plane logic configured to:
obtain candidate selections from a prefetch agent via the application programming interface;
cause the data plane logic to pre-warm a candidate media based on the candidate selections;
obtain a request for a selected media from a player agent via the application programming interface; and
cause the data plane logic to deliver the selected media from the candidate media in response to the request.

9. The system of claim 8, where the candidate media is prefetched from the media storage to an edge server of the distribution network associated with a media playback device.

10. The system of claim 9, where the prefetch agent and the player agent are associated with a network address of the media playback device.

11. The system of claim 8, where the candidate media is prefetched in a first data format for archival.

12. The system of claim 11, where the candidate media is pre-warmed into a second data format for streaming delivery.

13. The system of claim 8, where the data plane logic is configured to transfer-lessly pre-warm the candidate media.

14. The system of claim 8, where the candidate selections are based on a likelihood of interest and the request is based on an explicit user request.

15. A method, comprising:
monitoring user action to determine a likelihood of user interest;
prefetching a set of candidate media based on the likelihood;
obtaining an explicit user request for a media asset; and
streaming the media asset from the set of candidate media.

16. The method of claim 15, further comprising displaying a mural of media, and where the user action comprises navigation of the mural.

17. The method of claim 16, where prefetching the set of candidate media comprises a transfer-less pre-warming.

18. The method of claim 15, where prefetching the set of candidate media comprises a downloading a portion of the set of candidate media.

19. The method of claim 18, where the portion is discarded.

20. The method of claim 15, where the set of candidate media is stored in a first media format for archival and the media asset is streamed in a second media format for streaming.
